(19) United States
(12) Patent Application Publication
(10) Pub. No.: US 2004/0146597 A1
(43) Pub. Date: Jul. 29, 2004

(54) Mold for making packaging inserts and a process of fabricating the same

(75) Inventors: J. Michael Hays, Longbranch, WA (US); Samuel K. Ammar, Seattle, WA (US); Jamie Davis, Sumner, WA (US); Richard G. Adams, Elk Grove, CA (US); Jay H. Rolfs, Renton, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Premier Industries - EMPD

(21) Appl. No.: 10/372,756

(22) Filed: Feb. 21, 2003

Related U.S. Application Data
(60) Provisional application No. 60/359,469, filed on Feb. 22, 2002.

(51) Int. Cl. B29C 33/40

(52) U.S. Cl. 425/542; 264/219; 249/122

(57) ABSTRACT

The present invention is directed to molds for making packaging inserts having a pre-selected shape and a method of making the same. The shape of the mold is determined by first pre-selecting the shape of the packing insert. The shape of the packaging insert is dependent on the type of product that will be shipped. Once the shape of the packing insert is determined, the mold is then made by fabricating multiple parts, each part having a pre-selected shape. The shape of each part of the mold is determined such that when the mold is assembled, the mold forms a contiguous inner cavity having the shape (the inner cavity is the negative) of the pre-selected packaging insert. After the mold is assembled, beaded foam material is injected into the mold to form the packaging insert.

### CROSS-REFERENCE TO RELATED APPLICATION

This application claims benefit of U.S. Provisional Patent Application No. 60/359,469, filed Feb. 22, 2002, which is hereby incorporated by reference.

### FIELD OF THE INVENTION

The present invention relates generally to molds, and more particularly, to molds for making packaging inserts and the process of fabricating the same.

### BACKGROUND OF THE INVENTION

Currently in the shipping industry, fragile products, such as computers, televisions, video cameras and the like, are shipped in cardboard containers and held suspended in place by packaging inserts, such as corners, end caps, or the like. The packaging inserts are constructed from suitable materials, such as expanded beaded foam, which cradle the fragile products inside the cardboard containers.

Presently, one type of packaging insert, a plastic end cap, is fabricated by two different methods. The first employed method is to fabricate a mold having a pre-selected internal cavity via a casting process or by a computer numerical control (CNC) process. The mold is specifically fabricated for the particular pre-selected product to be shipped. After the mold is fabricated, plastic material is injected into the mold to form the end cap having the pre-selected shape. Fabricating molds by casting or CNC machining, while satisfactory to produce high volumes of product, is quite expensive. The expense usually negates the ability to fabricate molds for products having limited shipment quantities, such as specialty items or products sold by smaller manufacturers.

To address the aforementioned problems, the end caps have begun to be constructed without the typical cast molds or CNC fabricated molds previously used. Instead, parts of the end caps are fabricated by being punched out of extruded foam planks by dies having pre-selected shapes. The punched pieces are then assembled and fastened together via adhesive or heat welding to form the end cap. While this process results in a satisfactory end product, several deficiencies exist. First, the punching process leaves uneven fracture areas, which are not as smooth as an injected molded product. Additionally, by punching from a sheet of plastic, the end product is much more expensive due to the waste associated with such a method, not to mention the higher costs associated with purchasing the plastic sheets as compared to an injected molding material.

Therefore, there is a need in the packaging industry for a process of making packaging inserts from a mold that overcomes the deficiencies of the prior art.

### SUMMARY OF THE INVENTION

In accordance with one aspect of the present invention, a method of making a packaging insert mold for creating a packaging insert suitable for supporting a fragile article in a shipping container is provided. The method includes fabricating a plurality of separate parts of the mold, the separate parts of the mold having pre-selected shapes such that when the parts are assembled, the parts form a mold having a contiguous inner cavity that defines the pre-selected shape of the packaging insert. The separately fabricated parts are then assembled to form the mold having the contiguous inner cavity.

In accordance with another aspect of the present invention, a method of making a packaging insert for supporting an article in a shipping container is provided that includes The method includes fabricating a plurality of separate parts of the mold, the separate parts of the mold having pre-selected shapes such that when the parts are assembled, the parts form a mold having a contiguous inner cavity that defines the pre-selected shape of the packaging insert. The separately fabricated parts are then assembled to form the mold having the contiguous inner cavity. Once the mold is assembled, molding material is injected into the cavity of the mold to form the packaging insert, the packaging insert having the pre-selected shape of the packaging insert.

In accordance with another aspect of the present invention, a mold for making a packaging insert is provided having a pre-selected shape, the packaging insert utilized to support an article in a shipping container. The mold includes a base having a top planar surface, and a die having a pre-selected shape and a pre-selected height. The die is supported by the base. The mold further includes an upper mold assembly removably mounted to and supported by the base. The upper mold assembly includes a base section having a pre-selected shape and an opening adapted to receive the die such that a first cavity is formed between the die and the base section. The first cavity forms at least a portion of a single contiguous inner cavity defining the pre-selected shape of the packaging insert. The upper mold assembly also includes a top section having a shape corresponding to the opening in the base section and sized to be supported by the base section.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a perspective view of two packaging inserts supporting a fragile product prior to insertion into a shipping container;

FIG. 2 is an exploded perspective view of a packaging insert mold formed in accordance with the present invention;

FIG. 3 is an exploded perspective view showing the finished packaging insert of FIG. 1 formed from the mold of FIG. 2;

FIG. 4 is another embodiment of a packaging insert suitable for supporting a fragile product during shipping, formed by a mold constructed in accordance with the present invention;

FIGS. 5A-5E illustrates an embodiment of a packaging insert mold constructed in accordance with the present invention, suitable for making a pre-selected packaging insert of FIG. 4;

FIG. 6 is another embodiment of a packaging insert suitable for supporting a fragile product during shipping, formed by a mold constructed in accordance with the present invention;

FIGS. 7A-7D illustrates an embodiment of a packaging insert mold constructed in accordance with the present invention, suitable for making a pre-selected packaging insert of FIG. 6;

FIG. 8 is another embodiment of a packaging insert suitable for supporting a fragile product during shipping, formed by a mold constructed in accordance with the present invention;

FIGS. 9A-9D illustrates an embodiment of a packaging insert mold constructed in accordance with the present invention, suitable for making a pre-selected packaging insert of FIG. 8;

FIG. 10 is another embodiment of a packaging insert suitable for supporting a fragile product during shipping, formed by a mold constructed in accordance with the present invention;

FIGS. 11A-11F illustrates an embodiment of a packaging insert mold constructed in accordance with the present invention, suitable for making a pre-selected packaging insert of FIG. 10;

FIG. 12 is another embodiment of a packaging insert suitable for supporting a fragile product during shipping, formed by a mold constructed in accordance with the present invention; and

FIGS. 13A-13G illustrates an embodiment of a packaging insert mold constructed in accordance with the present invention, suitable for making a pre-selected packaging insert of FIG. 12.

### DETAILED DESCRIPTION OF THE PREFERRED EMBODIMENT

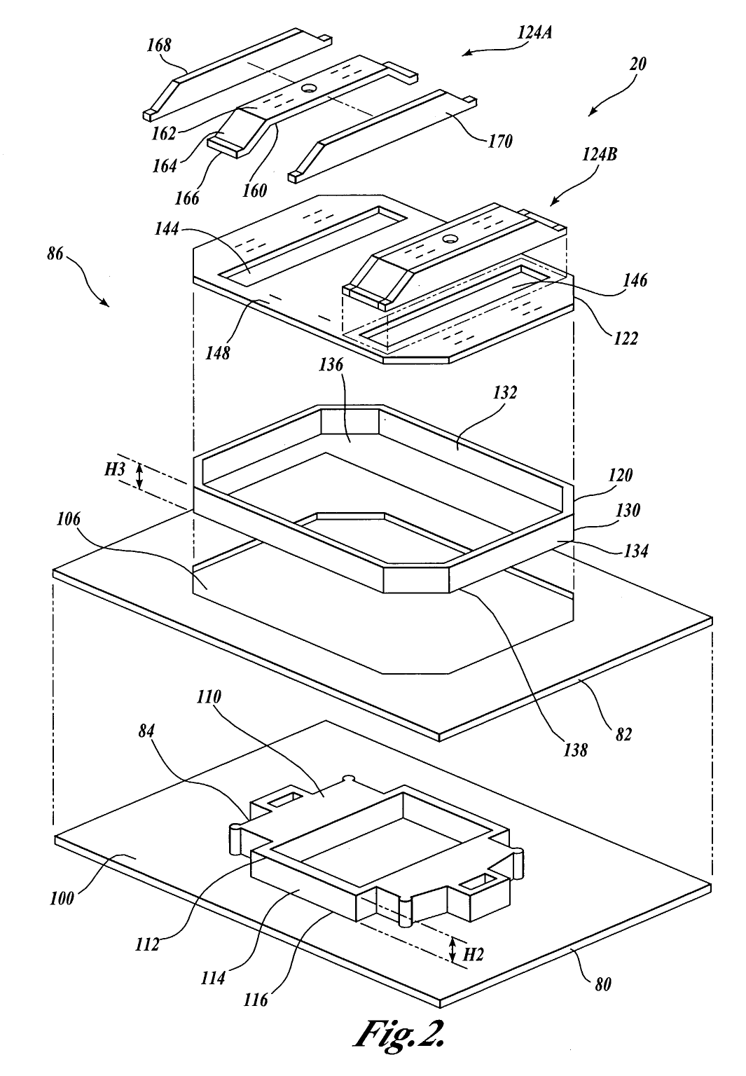

FIGS. 2, 3, 5A-5E, 7A-7D, 9A-9D, 11A-11F, and 13A-13G illustrate molds formed in accordance with embodiments of the present invention. Although the illustrative embodiments of the present invention are described for making computer packaging inserts, one skilled in the relevant art will appreciate that the disclosed molds and the process of making the molds are illustrative in nature and should not be construed as limiting the scope of the present invention to computer packaging inserts. It should therefore be apparent that the process of making the mold has wide application, and may be used in making packaging inserts for any fragile product, such as televisions, and video cameras, to name a few, or for making packaging inserts for other non-fragile products to be shipped.

The present invention will now be described with reference to the accompanying drawings where like numerals correspond to like elements. The present invention is directed to a mold for making packaging inserts for shipping products, for example, fragile products, such as computers, televisions, video cameras, and the like, and to a unique process for fabricating the mold. FIG. 2 is an exploded perspective view of a packaging insert mold, generally designated 20, constructed in accordance with the present invention. Generally described, the shape of a desired packaging insert is determined prior to fabricating the package insert mold 20. The shape of the packaging insert is dependent on the type of product to be shipped. Once the final shape of the packaging insert is determined, separate components of the mold 20 are fabricated into pre-selected shapes. The mold components are then assembled into the packaging insert mold 20, which defines a contiguous interior mold cavity having the predetermined shape of the desired packaging insert. Once the mold 20 is assembled, a suitable material, such as expanded beaded foam or the like, is injected into the cavity of the mold 20, resulting in a finished molded packaging insert having the desired predetermined shape.

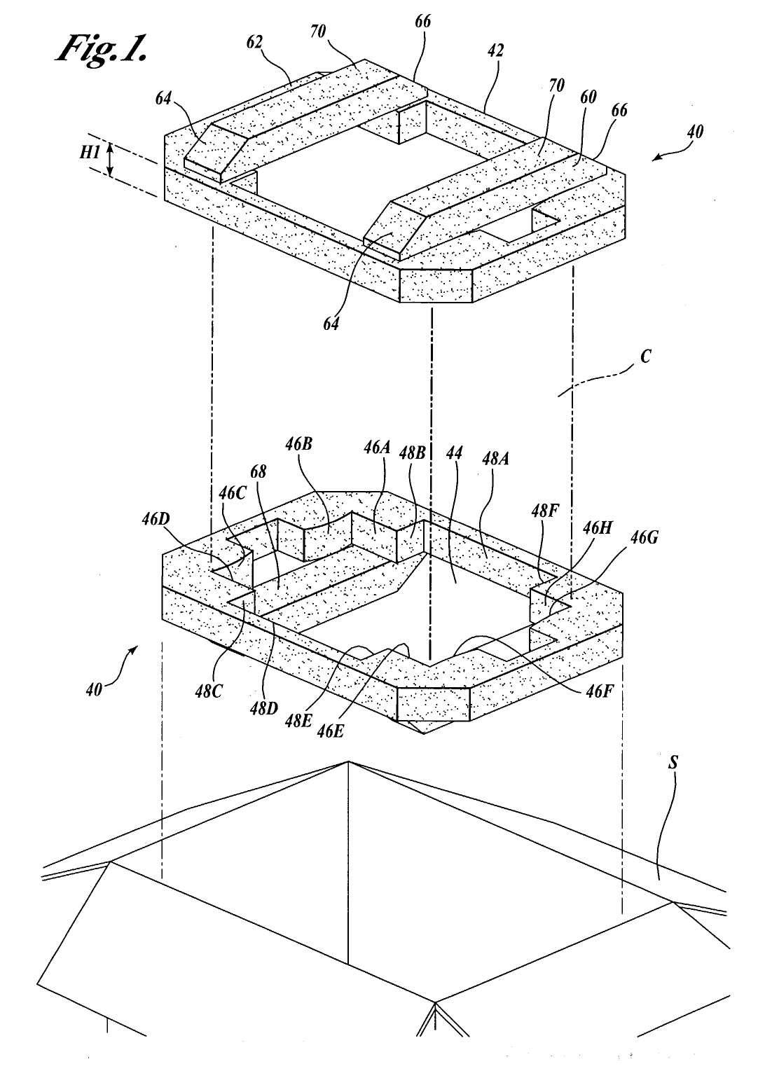

Referring now to FIG. 1, one type of packaging insert 40 having a shape pre-selected by a user will now be generally described. The packaging insert 40 is an end cap for a computer case C, shown in phantom. In operation, two of the packaging inserts 40 are placed around the ends of the computer case C in a tight fitting arrangement, such that the computer case C is sandwiched between the packaging inserts 40. After the packaging inserts 40 surround the ends of the computer case C, the combination is placed within a container S, typically of cardboard construction, for shipping.

The packaging insert 40 includes a body 42 having the general shape of a polyhedron, and two retaining members 60. The body 42 is designed with a predetermined height H1, and a predetermined width and length that corresponds to the particular dimensions of the shipping container to be used. The body 42 includes an open-ended cavity 44 suitable shaped and sized to seat the end of a computer case C in a tight fitting manner. In the embodiment shown, a plurality of interior side walls 46A-46H define a portion of the multi-sided cavity 44, which is adapted to receive the end of the computer case C. The body 42 may also include additional interior side walls 48A-48F which define a portion of the cavity 44, which is adapted for receiving a fragile product different than the computer case C. The additional side walls 48A-48F also reduce the amount of material needed to form the packaging insert 40 and allows the body to flex slightly when receiving the end of the computer case if needed. If desired, some of the walls may be bowed outwardly as shown by walls 46B, 46C, 46F, and 46G.

The packaging insert 40 further includes two elongate retaining members 60 integrally formed with and positioned on the outer surface of the body 42, i.e., the surface remote from the computer case C. In the embodiment shown, the retaining members 60 have a generally rectangular middle section 62 flanked by tapering ends 64 and 66. The retaining members 60 are disposed parallel to one other in a spaced apart fashion, perpendicular to the major axis of the packaging insert, in this illustrated packing insert. When the packaging insert 40 is positioned around the end of the computer case C, the cavity facing surface 68 of the retaining members 60 engage with the end surface of the computer case C, inhibiting the distance in which the computer case C may be inserted into the body 42. When packed in a shipping container S, the outer surfaces 70 of the retaining members 60 engage with the inner surfaces of the shipping container S. Thus, the body 42 and the retaining members 60 retain the end of the computer case C in a tight fitting arrangement within the shipping container S.

Referring now to FIG. 2, one embodiment of a packaging insert mold 20 suitable for making a pre-selected packaging insert 40 of the type described above and illustrated in FIG. 1 will now be described in detail. The packaging insert mold 20 is comprised of a base 80, an alignment member 82, a die 84, and an upper mold assembly 86, all of which are preferably constructed as individual parts. Each mold part has a pre-selected shape such that when the mold parts are assembled, the mold parts form the mold 20 having an inner mold cavity. The inner mold cavity of the mold defines the pre-selected shape of the packaging insert 40. The individual parts that make up the mold 20 will now be described in turn.

The base 80 and the alignment member 82 may be generally rectangular in shape, as shown in FIG. 2, or may be any other shape that has a sufficient top surface area for overlapping the upper mold assembly 86. The illustrated base 80 is a plate-like member having a top planar surface 100. The alignment member 82 is also a plate-like member having a bottom planar surface (not shown) having a length and width the same as the base 80. The alignment member 82 includes an opening 106 preferably centered in the alignment member 82. The opening 106 corresponds in shape and size to the outer perimeter formed by the upper mold assembly 86, described below. In the embodiment shown, the opening 106 is octagonal; however, it will be appreciate that any shape may be used, such as a rectangle. When assembled, the alignment member 82 overlays the base 80 such that the top planar surface 100 of the base 80 is juxtaposed against the bottom planar surface of the alignment member 82.

As seen best in FIG. 2, the die 84 is a unitary member that includes a top planar surface 110, a bottom planar surface (not shown), and side walls 112. The outer surfaces 114 of the side walls 112 define an outer perimeter 116 that corresponds to the shape and size of the packaging insert cavity. Thus, the outer perimeter defines the walls of the cavity, including walls 46A-46H and 48A-48F shown in FIG. 1 and described above. In the illustrative embodiment, the outer surfaces 114 of the side walls 112 correspond to the multi-sided walls of the packaging insert cavity. The height H2 of the die 84 is pre-selected to be substantially equal to the height of the packaging insert body. When assembled, the die 84 is centered on the base 80, and thus, centered within the opening 106 of the alignment member 82 when the bottom planar surface of the alignment member overlays the top planar surface 100 of the base 80. The die 84 is secured to the base 80 by any suitable mechanism, such as compression pins, screws, bolts, welding, or any combination thereof, to name a few. The die 84 is suitably dimensioned such that when centered within the opening 106 of the alignment member 82, a cavity (not shown) is formed around the die 84, between the outer surfaces 114 and the interior surface of the upper mold assembly 86, as will be described in more detail below. As such, it will be appreciated that the cavity created between the outer surface 114 the die 84 and the upper mold assembly 86 is substantially equal in size and shape as the packaging insert body.

With continued reference to FIG. 2, the upper mold assembly 86 includes a base section 120, a top section 122, and two protruding sections 124A and 124B, all of which are individually formed. The base section 120 includes a plurality of side walls 130 of predetermined thickness contiguously connected to form a ring-like member. The height H3 of the side walls 130 is pre-selected to be substantially equal to the height of the packaging insert body and of the die 84. The base section 120 has a thickness suitable for supporting the top section 122. The inner surfaces 132 of the side walls 130 are generally planar and define a cavity 136 that corresponds in shape and size to the predetermined outer shape of the packaging insert body. The outer surfaces 134 of the side walls 130 of the base section 120 are also generally planar and define a perimeter that corresponds to the shape of the opening 106 in the alignment member 82. The base section 120 is suitably sized to be received within the opening 106 in the alignment member 82 such that the outer surfaces 134 of the side walls 130 abut against the inner side walls formed by the opening 106 when assembled. As such, it will be appreciated that the size of the opening 106 in the alignment plate 82 is determined by the pre-selected dimensions of the packaging insert body and the thickness of the base section 120. When supported by the base 80, the inner and outer surfaces 132 and 134 of the side walls 130 are substantially orthogonal to the top planar surface 100 of the base 80.

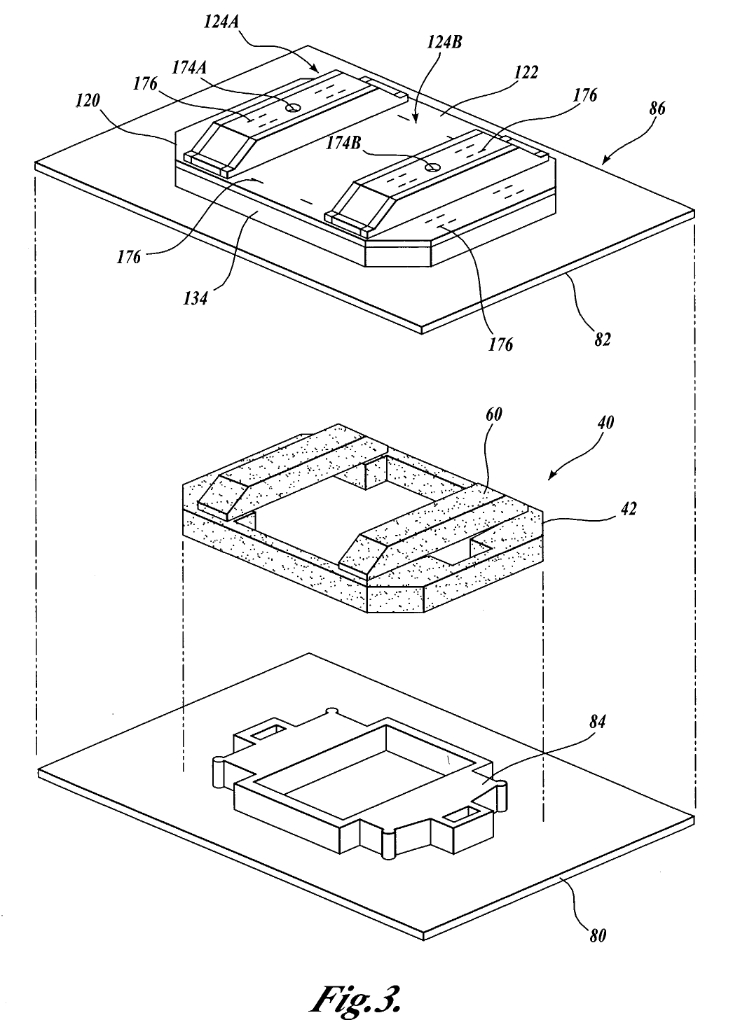

The top section 122 of the upper mold assembly 86 is a plate-like member shaped and sized to correspond to the outer perimeter of the base section 120. The top section 122 has a top planar surface 148 and a bottom planar surface (not shown). The top section 122 is formed with two openings 144 and 146. In the embodiment shown, the openings 144 and 146 are formed in the shape of elongate rectangles, spaced-apart and perpendicular to the major axis of the top section 122. The openings 144 and 146 are suitably positioned in the top section 122 to allow for the formation of the retaining members of the packaging insert when material is injected into the packaging insert mold. When assembled, the bottom planar surface (not shown) of the top section 122 is supported by the top surface of the base section 120 and the top planar surface 110 of the die 84, such that the top planar surface 148 of the top section 122 lies substantially parallel to the top planar surface 100 of the base 80. When the top section 122 is properly aligned with the base section 120, the side walls of the top section 122 are flush with the outer surfaces 134 of the base section 120, as best shown in FIG. 3. When the top section 122 is placed on the die 84, the cavity formed between the die 84 and the base section 120 is partially enclosed. Thus, the bottom planar surface of the top section 122 delimits a portion of the inner mold cavity.

Still referring to FIG. 2, the upper mold assembly 86 further includes two protruding sections 124A and 124B configured to surround the openings 144 and 146 of the top section 122. Each protruding section 124A and 124B is substantially equivalent in shape and construction, thus, only one will be described in detail. The protruding section 124A includes a middle section 160 and two end wall sections 168 and 170. The middle section 162 includes a main portion 162 and two tapering portions 164, one extending from each end of the main portion 162, thereby forming a generally C-shaped member. Connected to the ends of the tapering portions 164 are lip portions 166, which lie parallel to the main portion 162 of the middle section 160. The end wall sections 168 and 170 are plate-like members and are identical in shape and structure, the shape conforming to the edges of the main, tapering, and lip portions 162, 164, and 166 of the middle sections 160. When assembled to form the protruding section 124B, the end wall sections 168 and 170 abut against the longitudinal edges of the middle section 160 to define a cavity (not shown). The shape and size of the cavity corresponds to the shape and size of the retaining members 60 of the packaging insert. When assembled on the mold, the protruding sections 124A and 124B surround the openings in the top section 122, as best shown in FIG. 3. This results in the cavities (not shown), formed by the protruding sections, to communicate with the cavity formed between the die 84 and the base section 120.

One exemplary process of fabricating and assembling the parts of the mold 20 in accordance with the present invention will now be described in detail with reference to FIGS. 2 and 3. Two plates of a suitable material, such as aluminum, having similar dimensions are obtained. The plates have a top surface area large enough to overlap the upper mold assembly 86 and have a thickness in the range of approximately 1/8″ to 3/8″. One of the plates obtained is utilized as the base 80, while the other sheet is utilized as the alignment member 82. The opening 106 in the alignment member is formed by removing material from the alignment member 82 in a shape and size that corresponds to the outer perimeter of the base section 120. The opening 106 may be formed in a variety of ways, including being punched out by a suitable punching process, or being cut out by a plasma arc cutter or an electron beam cutter, to name a few. In one actual embodiment of the invention, the opening 106 is cut out using a jet of high pressured fluid generated by a high pressure fluid machine.

When the size of the opening 106 is determined, it will be appreciated that the additional thickness of the side walls 130 of the base section 120 of the upper mold assembly 86 must be added to the predetermined size of the packing insert body. If the opening is created by punching, plasma arc cutting, or water jet cutting, a single unitary piece may be cut out to form the opening 106. The single unitary piece may then be saved for later use as the top section 122 of the upper mold assembly 86. Once the alignment member 82 is fabricated, it is placed on top of the base 80.

Turning now to the fabrication of the die 84, the die 84 may be fabricated by being cut from a plate of material, such as aluminum, by any of the methods described above, or alternatively, may be cast from a suitably shaped mold. If the die 84 is cut out from a plate of material, the thickness of the plate is pre-selected to be substantially equal to the desired thickness of the packaging insert body 42 to be formed. In one embodiment, the thickness of the die is in the range of approximately 7/8″ to 1¼.″ The die 84 is fabricated such that the outer perimeter of the die 84 corresponds in shape and size to the inner cavity of the packaging insert 40. After the die 84 is fabricated, the die 84 is centered within the opening 106 of the alignment member 82 and secured to the top planar surface of the base 80 by any suitable attachment mechanism, such as compression pins, screws, bolts, welding, or any combination thereof, to name a few.

Referring now to FIG. 2, the upper mold assembly 86 may be fabricated by starting with the top section 122. If the opening 106 was cut using a plasma arc cutter or a water jet cutter, the unitary piece cut out to form the opening 106 may be used as the top section 122. Alternatively, as will be appreciated by those skilled in the art, the top section 122 may also be cut from a plate of material having the shape of the outer perimeter of the opening 106. Once the top section 122 is obtained, two openings 144 and 146 are cut into the top section 122. The openings 144 and 146 correspond to the retaining members of the packaging insert and may be cut using any one of the methods described above.

Next, the base section 120 may be fabricated by cutting the necessary shape of the base section 120 out of a plate of material, such as aluminum, having the necessary thickness, which is equal to the thickness of the packaging insert body. Alternatively, the base section 120 may be formed into the necessary shape by any known casting process, or by cutting a strip of suitable material having the predetermined thickness and then bending the strip of material into the necessary shape. Using any of the aforementioned methods, the base section 120 is fabricated such that the outer perimeter of the base section 120 corresponds to the shape and size of the opening in the alignment member 82, while the inside perimeter of the base section 120 corresponds in shape and size to the pre-selected outer perimeter of the packaging insert body. After the base section 120 is fabricated, the base section 120 is inserted into the opening 106 of the alignment member 82 and is supported by the base 80. The top section 122 is then placed on top of the base section 120 and properly aligned, as best shown in FIG. 3. Once the top section 122 is aligned on the base section 120, the top section is removably secured to base 80 by any suitable mechanism, such as clamps, thereby securing base section 120 between the base 80 and the top section 122. Alternatively, the top section may be fixedly secured to the base section 120 by welding, compression pins, or any other suitable attachment mechanism. In this embodiment, the upper mold assembly is removably secured to base 80 by any suitable mechanism, such as clamps. As will be appreciated by those skilled in the art, the alignment member 82 maintains the upper mold assembly 86 aligned with respect to the die 84.

Finally, the protrusion sections 124A and 124B of the upper mold assembly 86 are fabricated by cutting the necessary shapes out of a plate of material, such as aluminum. After the middle section 160 and the end wall sections 168 and 170 are fabricated, they are positioned on the outer surface 148 of the top section 122 so as to surround the rectangular openings 144 and 146. The protrusion sections 124A and 124B form a part of the mold cavity, which defines the retaining members 60 of the packaging insert 40. The protrusion sections 124A and 124B may be held together and in place by welding, compression pins, or any other suitable attachment mechanism.

Once the mold 20 is completely assembled, a contiguous inner mold cavity is formed having the pre-selected shape of the packaging insert. The assembled mold may then be operably connected in a conventional manner to an injection-molding machine. After the mold 20 is connected to the injection molding machine, any suitable injection molding material, such as expanded beaded foam or the like, may be injected into the mold to form the packaging insert. It will be appreciated that suitable apertures 174A and 174B are disposed in protrusion sections 124A and 124B, as shown best in FIG. 3, to allow injection of the molded material into the inner cavity of the mold.

After the injection molding material is injected into the mold and time suitable for allowing the insert to cool has elapsed, the upper mold assembly 86 is separated from the base 80 for removing the completed packaging insert 40. It will be appreciated that relief angles may be formed on the die 84, as known in the art, to aid in the removal of the insert if desired. Additionally, it will be appreciated that steam vents 176 may be disposed in several parts of the mold 20, as best shown in FIGS. 2 and 3, for allowing fusion of the injected beaded foam material.

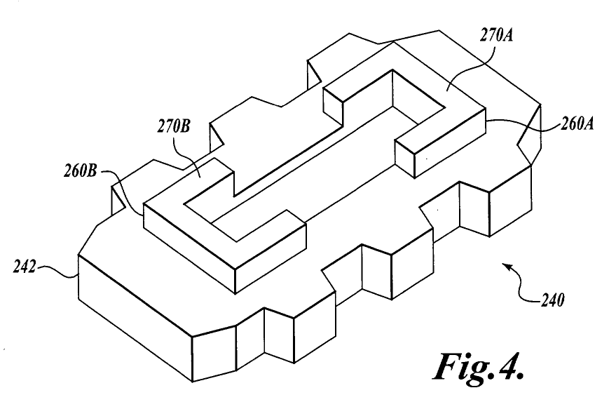

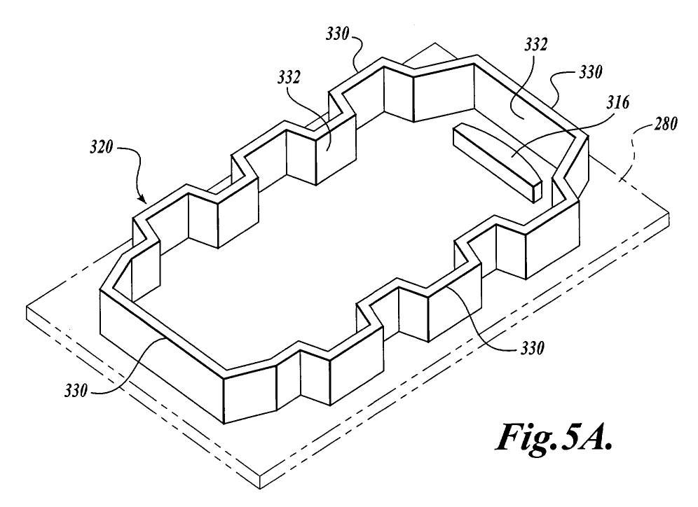

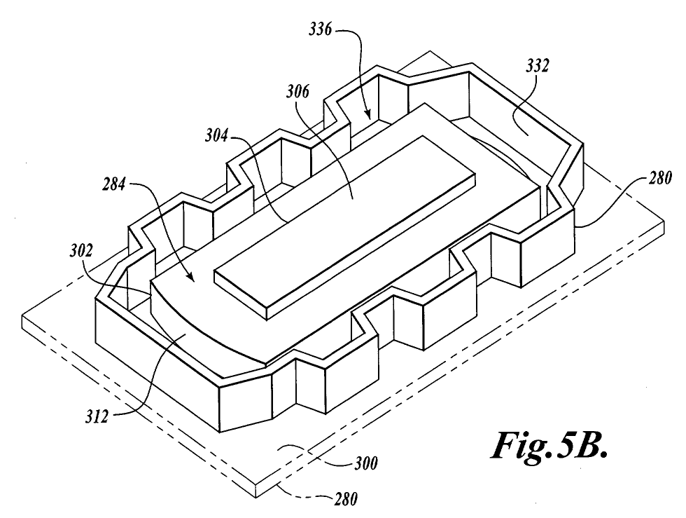

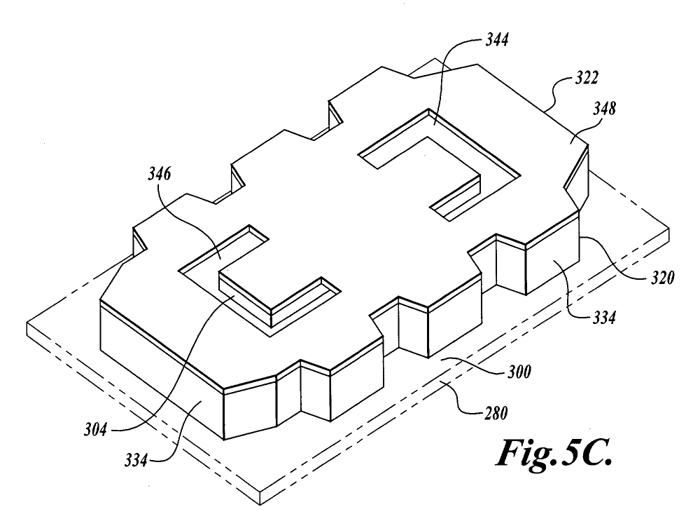

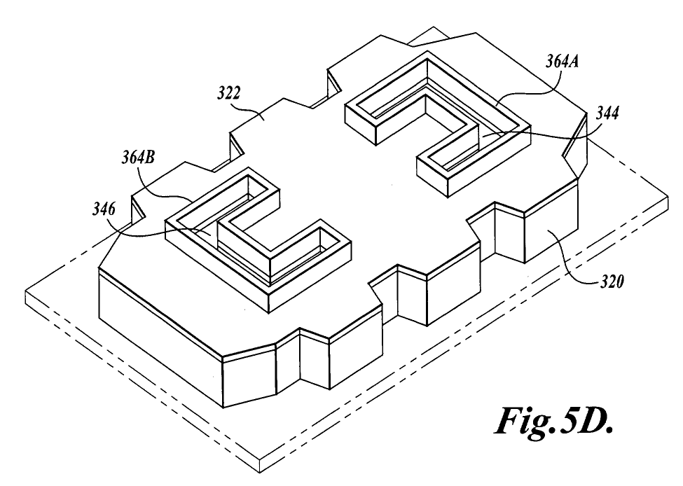

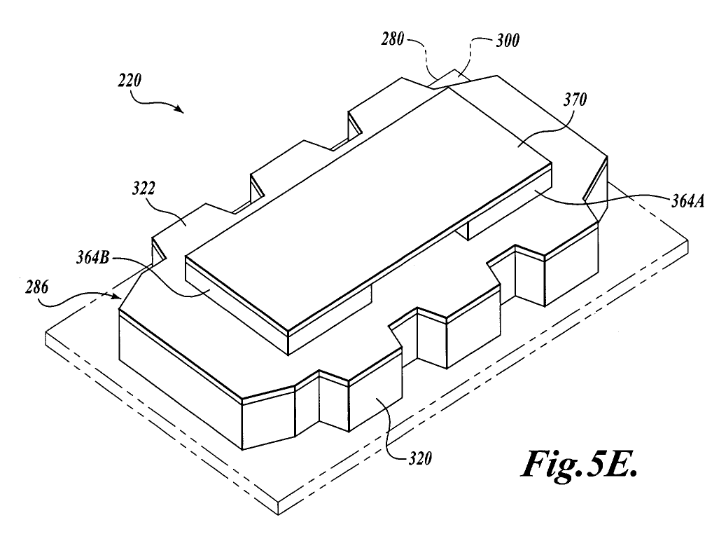

While one exemplary embodiment of a mold made from the unique method of the present invention has been described in detail with reference to FIGS. 1-3, it will be appreciated that an unlimited number of packaging inserts and their corresponding molds can be fabricated by utilizing the aforementioned mold fabricating method. Referring now to FIGS. 5A-5E, 7A-7D, 9A-9D, 11A-11F, and 13A-13G, there are shown a few examples of packaging insert molds made by the mold fabricating method of the present invention. The final packaging inserts formed by the respective molds of FIGS. 5A-5E, 7A-7D, 9A-9D, 11A-11F, and 13A-13G are shown in FIGS. 4, 6, 8, 10, and 12. Each packaging insert and its corresponding packaging insert mold will now be described in turn.

Referring now to FIGS. 4 and 5A-5E, another embodiment of a mold 220 and its corresponding insert 240 is shown. The mold is made from the method of the present invention described above including: 1) preselecting the shape of a desired packaging insert; 2) fabricating separate components of the mold into pre-selected shapes; and 3) assembling the mold components into the packaging insert mold, which defines a contiguous interior mold cavity having the predetermined shape of the desired packaging insert. Once the mold has been assembled, a bead foam material may be injection into the mold to form the preselected packaging insert. The mold 220 and its corresponding insert 240 is identical in construction, materials, and operation as the mold 20 and its corresponding insert 40 described above, except for the differences which will now be described in detail.

FIG. 4 illustrates a packaging insert 240 suitable for supporting a fragile product during shipping. The packaging insert 240 includes a multi-sided body 242 and two retaining members 260A and 260B. The body 242 is designed with a predetermined height, width, and length that corresponds to the particular dimensions of the shipping container to be used for shipping. The body 242 includes an open-ended cavity (not shown) suitably shaped and sized to seat the end of a fragile product, such as computer case, in a tight fitting manner. The retaining members 260A an 260B are integrally formed with and positioned on the outer surface of the body 242, i.e., the surface remote from the fragile product. In the embodiment shown, the retaining members 260A and 260B have a generally C-shaped geometry and are disposed in a spaced-apart fashion. When packed in a shipping container, the outer surfaces 270A and 270B of the retaining members 260A and 260B, respectively, engage with the inner surfaces of the shipping container. Thus, the body 242 and the retaining members 260A and 260B retain the end of fragile product in a tight fitting arrangement within the shipping container.

Referring now to FIGS. 5A-5E, one embodiment of a packaging insert mold 220 suitable for making a pre-selected packaging insert 240 of the type described above and illustrated in FIG. 4, will now be described in detail. As best shown in FIGS. 5B and 5E, the packaging insert mold 220 is comprised of a base 280, a die 284, and an upper mold assembly 286, all of which are preferably constructed as individual components. Each mold component has a pre-selected shape such that when the mold components are assembled, the mold components form the mold 220 having a contiguous inner mold cavity (not shown). The inner mold cavity of the mold 220 defines the pre-selected shape of the packaging insert 240 (FIG. 4). The individual components that make up the mold 220 will now be described in turn.

The base 280 may be generally rectangular in shape, as shown in FIG. 5E, or may be any other shape that has a sufficient top surface area for overlapping the upper mold assembly 286. The base 280 is a plate-like member having a top planar surface 300. Secured to the top planer surface 300 of the base when assembled is the die. Referring now to FIG. 5B, the die 284 is formed by a generally rectangular support base 302 and a rectangular top member 304. The support base 302 and the top member 304 may be secured together by any suitable mechanism, such as compression pins, screws, bolts, welding, or any combination thereof, to name a few. The top member 304 has a top planar surface 306, and the support base 302 has a bottom planar surface (not shown) and outer side wall surfaces 312. The outer side wall surfaces 312 define an outer perimeter that corresponds to the shape and size of the open ended cavity of the packaging insert body. As such, it will be appreciated that the outer perimeter defines the interior walls of the inner mold cavity.

The height of the die 284, i.e., from the bottom surface of the support base 302 to the top planar surface 306 of the top member 304, is pre-selected to be substantially equal to the height of the packaging insert body. The die 284 may optionally include an arcuate-like member 316, best shown in FIG. 5A, which can be individually formed and fastened to either the support base of the die or the base 280.

Referring now to FIG. 5B, the die 284 may be centered on the base 280 and secured thereto by any suitable mechanism, such as compression pins, screws, bolts, welding, or any combination thereof, to name a few. When assembled, the die 284 is suitably dimensioned such that a cavity 336 is formed around the die 284, between the outer side wall surfaces 312 and the interior surface of the upper mold assembly, as will be described in more detail below. Additionally, the cavity 336 is delimited by the top planar surface 300 of the base 280. As such, it will be appreciated that the cavity 336 is substantially equal in size and shape as the packaging insert body.

Referring now to FIG. 5E, the upper mold assembly 286 of the mold 220 includes a base section 320, a top section 322, and protruding sections 364A and 364B, all of which are individually formed. As best shown in FIG. 5A, the base section 320 includes a plurality of side walls 330 of predetermined thickness contiguously connected to form a ring-like member. The height of the side walls 330 are pre-selected to be substantially equal to the height of the combination of the packaging insert body and the die (i.e., from the bottom planar surface of the support base to the top planar surface of the top member). The base section 320 has a thickness suitable for supporting the top section 322. The inner surfaces 332 of the side walls 330 are generally planar and define the outer boundary of the cavity 336 (FIG. 5B), the boundary corresponding in shape and size to the predetermined outer shape (perimeter) of the packaging insert body. When assembled, the base section 320 is positioned around the die and is supported by the base 280 such that the cavity 336 is formed between the outer surfaces 312 of the die 284 and the inner surfaces 332 of the base 320, and is delimited by the top planar surface 300 of the base 280, as shown best in FIG. 5B. In this position, the inner surfaces 332 of the base section 320 are substantially orthogonal to the top planar surface 300 of the base 280.

Referring now to FIG. 5C, the top section 322 of the upper mold assembly is a plate-like member shaped and sized to correspond to the outer perimeter of the base section 320. The top section 322 has a top planar surface 348 and a bottom planar surface (not shown). The top section 322 is formed with two openings 344 and 346. In the embodiment shown, the openings 344 and 346 are spaced-apart with a generally C-shaped geometry, the open sides of which face one another. The openings 344 and 346 are suitably positioned in the top section 322 to allow for the formation of the retaining members 260A and 260B (FIG. 4) of the packaging insert 240 (FIG. 4) when material is injected into the packaging insert mold. When assembled, the bottom planar surface (not shown) of the top section 322 is supported by the top surface of the base section 320 and the top planar surface (hidden by the top section) of the top member 304 of the die. In this position, the top planar surface 348 of the top section 322 lies substantially parallel to the top planar surface 300 of the base 280. When the top section 322 is properly aligned with the base section 320, the side walls of the top section 322 are flush with the outer surfaces 334 of the base section 320. When the top section 322 is placed on the die, the cavity 336 (FIG. 5B) formed between the die and the base section 320 is partially enclosed. Thus, the bottom planar surface of the top section 322 delimits a portion of the inner mold cavity.

Referring now to FIG. 5D, the upper mold assembly further includes two protruding sections 364A and 364B configured to surround the openings 344 and 346 of the top section 322. Each protruding section 364A and 364B is substantially equivalent in shape and construction, thus, only one will be described in detail. The protruding section 364A includes contiguous side walls defining the perimeter of the retaining member 260A (FIG. 4), and a top plate 370 shown in FIG. 5E which defines the top wall and the retaining member 260A. As such, the protruding section 364A and the top plate 370 forms an interior cavity (not shown). The shape and size of the interior protruding section cavity corresponds to the shape and size of the retaining member 260A (FIG. 4) of the packaging insert. When assembled, the protruding sections 364A and 364B surround the openings 344 and 346, in the top section 322, respectively, as best shown in FIG. 5D. This allows the protruding section cavities (not shown) formed by the protruding sections 364A and 364B to communicate with the cavity 336 (FIG. 5B) formed between the die and the base section 320. Thus, the protruding section cavities, in conjunction with the cavity 336, form the inner mold cavity for creating the packaging insert 240.

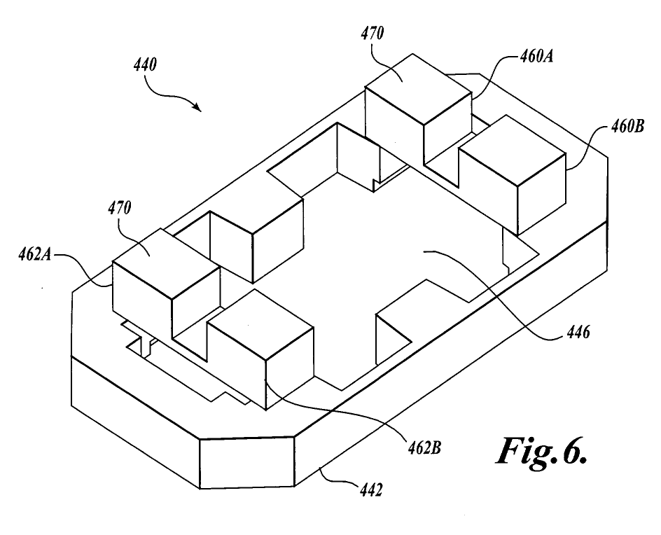

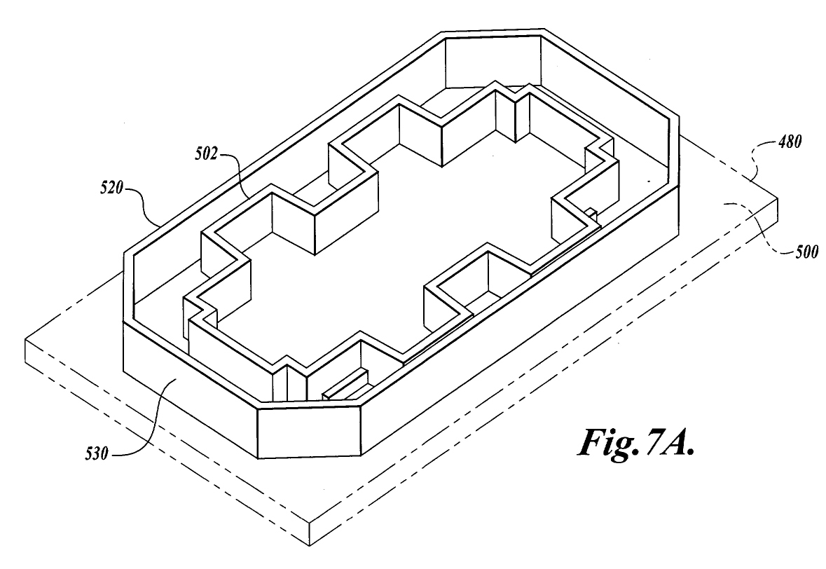

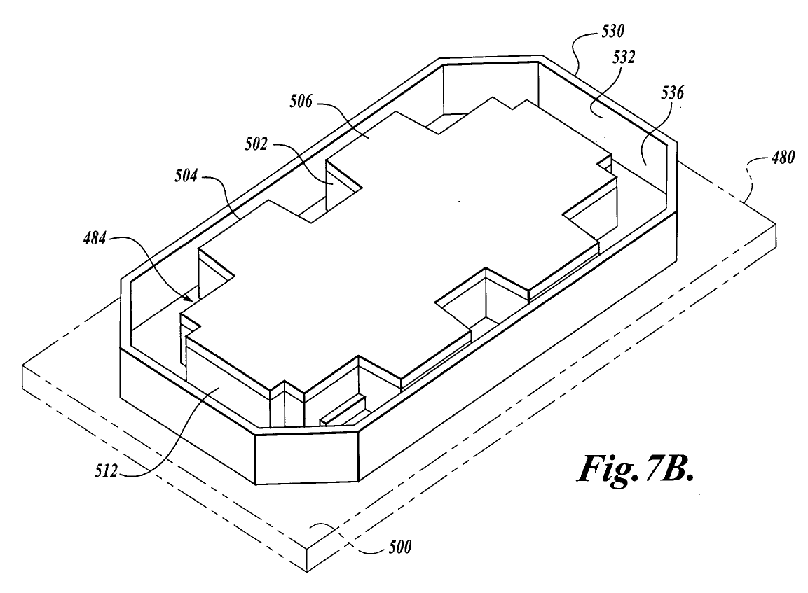

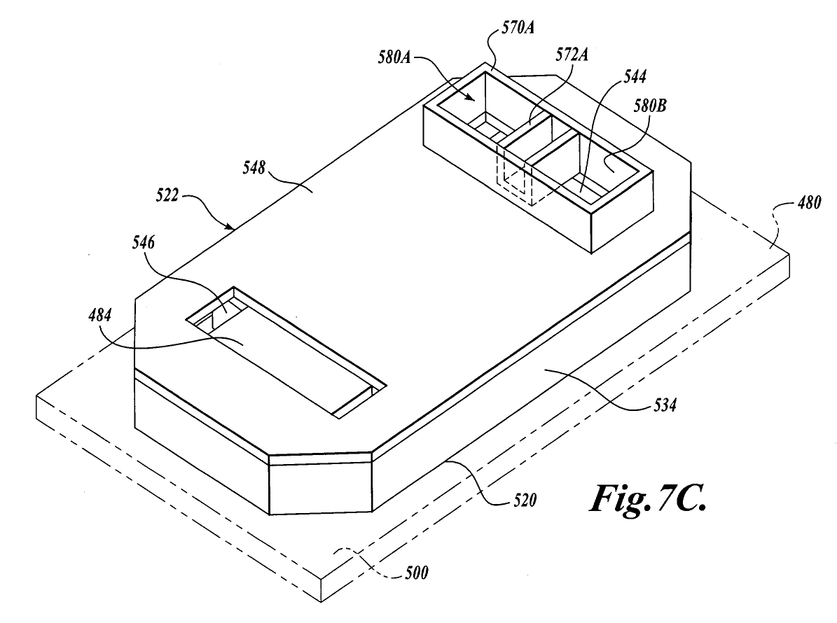

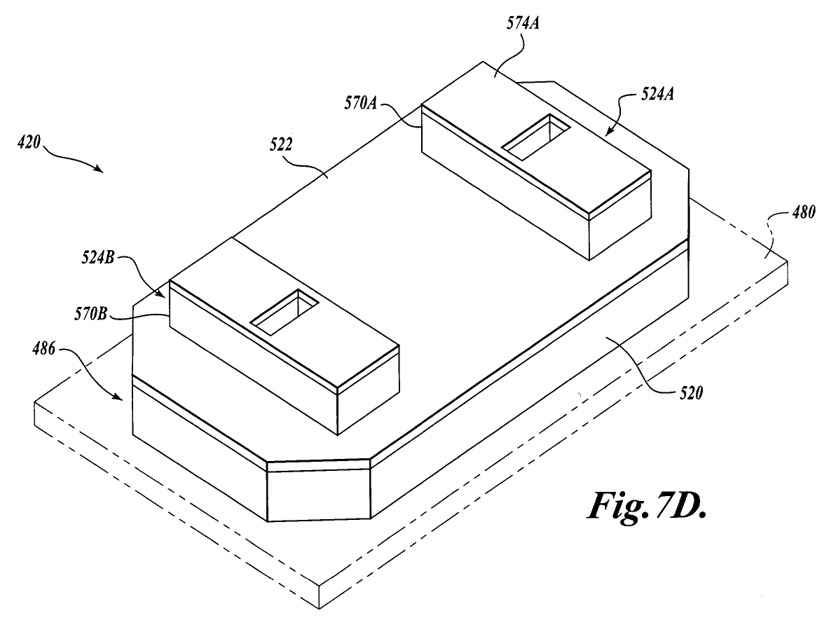

Referring now to FIGS. 6 and 7A-7D, another embodiment of a mold 420 and its corresponding insert 440 is shown. The mold is made from the method of the present invention described above including: 1) preselecting the shape of a desired packaging insert; 2) fabricating separate components of the mold into pre-selected shapes; and 3) assembling the mold components into the packaging insert mold, which defines a contiguous interior mold cavity having the predetermined shape of the desired packaging insert. Once the mold has been assembled, a bead foam material may be injection into the mold to form the preselected packaging insert. The mold 420 and its corresponding insert 440 is identical in construction, materials, and operation as the mold 20 and its corresponding insert 40 described above, except for the differences which will now be described in detail.

FIG. 6 illustrates a packaging insert 440 suitable for supporting a fragile product during shipping. The packaging insert 440 includes a multi-sided body 442 and two pairs of retaining members 460A-460B and 462A-462B. In the embodiment shown, the multi-sided body 442 has an octagonal shape. However, it will be apparent that other multi-sided geometries may be used. The body 442 is designed with a predetermined height, width, and length that corresponds to the particular dimensions of the shipping container to be used for shipping. The body 442 includes an open-ended cavity 446 suitable shaped and sized to seat the end of a fragile product, such as computer case, in a tight fitting manner. The retaining members 460A-460B and 462A-462B are integrally formed with and positioned on the outer surface of the body 442, i.e., the surface remote from the fragile product. In the embodiment shown, the pairs of retaining members 460A-460B and 462A-462B have a generally rectangular shaped geometry and are disposed in a spaced apart fashion. When packed in a shipping container, the outer surfaces 470 of the retaining members 460A-460B and 462A-462B engage with the inner surfaces of the shipping container. Thus, the body 442 and the retaining members 460A-460B and 462A-462B retain the end of the fragile product in a tight fitting arrangement within the shipping container.

Referring now to FIGS. 7A-7D, one embodiment of a packaging insert mold 420 suitable for making a pre-selected packaging insert 440 of the type described above and illustrated in FIG. 6 will now be described in detail. As best shown in FIGS. 7B and 7D, the packaging insert mold 420 is comprised of a base 480, a die 484, and an upper mold assembly 486, all of which are preferably constructed as individual components. Each mold component has a pre-selected shape such that when the mold components are assembled, the mold components form the mold 420 having an inner mold cavity, which defines the pre-selected shape of the packaging insert. The individual components that make up the mold 420 will now be described in turn.

The base 480 may be generally rectangular in shape, as shown in FIGS. 7A and 7B, or may be any other shape that has a sufficient top surface area for overlapping the upper mold assembly. The base 480 is a plate-like member having a top planar surface 500. Secured to the top planer surface 500 of the base 480 when assembled is the die 484. The die 484 is formed by a multi-sided, hollow support base 502 and a multi-sided top member 504. The support base 502 and the top member 504 may be secured together by any suitable mechanism, such as compression pins, screws, bolts, welding, or any combination thereof, to name a few. The top member 504 has a top planar surface 506, and the support base 502 has a bottom planar surface (not shown) and outer side wall surfaces 512. The outer side wall surfaces 512 define an outer perimeter that corresponds to the shape and size of the packaging insert cavity. Thus, the outer perimeter defines the interior walls of the inner mold cavity.

The height of the die 484 is pre-selected to be substantially equal to the height of the packaging insert body. When assembled, the die 484 is preferably centered on the base 480 and secured thereto by any suitable mechanism, such as compression pins, screws, bolts, welding, or any combination thereof, to name a few. The die 484 is suitably dimensioned such that when secured to the base, a cavity 536 is formed around the die 484, between the outer side wall surfaces 512 and the interior surface of the upper mold assembly, as will be described in more detail below. Additionally, the cavity 536 is delimited by the top planar surface 500 of the base 480. As such, it will be appreciated that the cavity 536 is substantially equal in size and shape as the packaging insert body.

Referring now to FIG. 7D, the upper mold assembly 486 of the mold 420 includes a base section 520, a top section 522, and protruding sections 524A and 524B, all of which are individually formed. As best shown in FIG. 7A, the base section 520 includes a plurality of side walls 530 of predetermined thickness contiguously connected to form a ring-like member. The height of the side walls 530 is pre-selected to be substantially equal to the height of the packaging insert body and of the die 484 (i.e., from the bottom planar surface of the support base to the top planar surface of the top member), as best shown in FIG. 7B. The side walls 530 of the base section 520 have a thickness suitable for supporting the top section 522. The inner surfaces 532 of the side walls 530 are generally planar and define the outer boundary of the cavity 536, the outer boundary corresponding in shape and size to the predetermined outer shape of the packaging insert body. When assembled, the base section 520 is positioned around the die and is supported by the base 480 such that the cavity 536 is formed between the outer surfaces 512 of the die 484 and the inner surfaces 532 of the base 520, and is delimited by the top planar surface 300 of the base 280. In this position, the inner surfaces 532 of the side walls 530 are substantially orthogonal to the top planar surface 500 of the base 480.

Referring now to FIG. 7C, the top section 522 of the upper mold assembly is a plate-like member shaped and sized to correspond to the outer perimeter of the base section 520. The top section 522 has a top planar surface 548 and a bottom planar surface (not shown). The top section 522 is formed with two openings 544 and 546. In the embodiment shown, the openings 544 and 546 are formed in a generally rectangular geometry, spaced apart and disposed transverse to the major axis of the top section 522. The openings 544 and 546 are suitably positioned in the top section 522 to allow for the formation of the retaining members of the packaging insert when material is injected into the packaging insert mold.

When assembled, the bottom planar surface (not shown) of the top section 522 is supported by the top surface of the base section 520 and the top planar surface 500 of the top section of the die, such that the top planar surface 548 of the top section 522 lies substantially parallel to the top planar surface 500 of the base 480. When the top section 522 is properly aligned with the base section 520, the side walls of the top section 522 are flush with the outer surfaces 534 of the base section 520, as best shown in FIG. 7C. When the top section 522 is placed on the die, the cavity 536 (FIG. 7B) formed between the die and the base section 520 is partially enclosed. Thus, the bottom planar surface of the top section 522 delimits a portion of the inner mold cavity.

Referring now to FIGS. 7C and 7D, the upper mold assembly 486 further includes two protruding sections 524A and 524B configured to surround the openings 544 and 546, respectively, of the top section 522. Each protruding section 524A and 524B is substantially equivalent in shape and construction, thus, only one will be described in detail. The protruding section 524A includes a rectangular hollow member 570A defined by side walls, a U-shaped member 572A and a top plate 574A. When assembled to form the protruding section 524A, the longitudinal side walls of the hollow member 570A abut against the side surface of the U-shape members 572A to define two equally dimensioned protruding section cavities 580A and 580B. The shape and size of the cavities correspond to the shape and size of the retaining 460A and 460B members of the packaging insert 440 (FIG. 6). When assembled on the mold, the protruding sections 524A and 524B surround the openings in the top section 522, as best shown in FIGS. 7C and 7D. This allows the protruding section cavities 580A and 580B formed by the protruding sections to communicate with the cavity formed between the die 484 and the base section 520. Thus, the protruding section cavities, in conjunction with the cavity 536, form the inner mold cavity for creating the packaging insert 440.

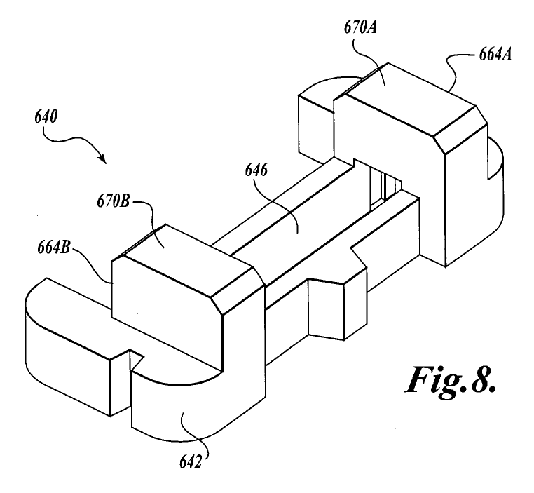

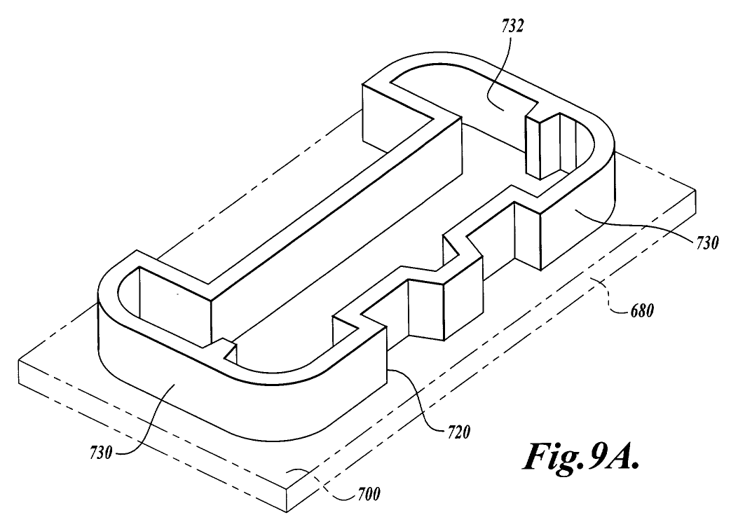

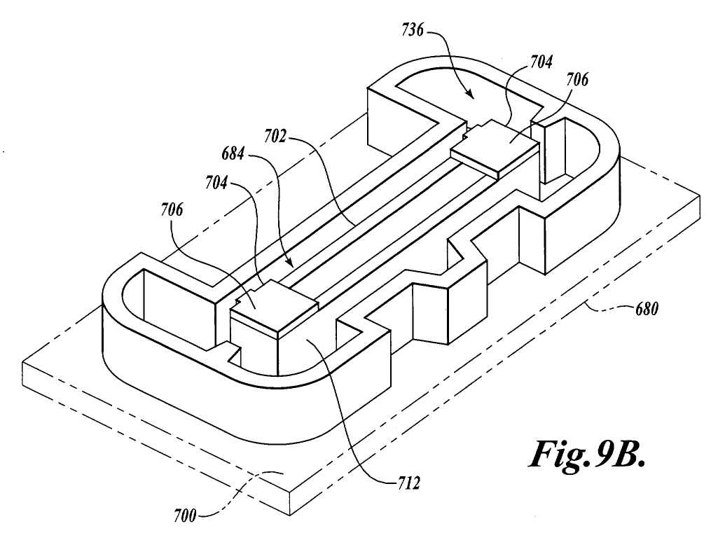

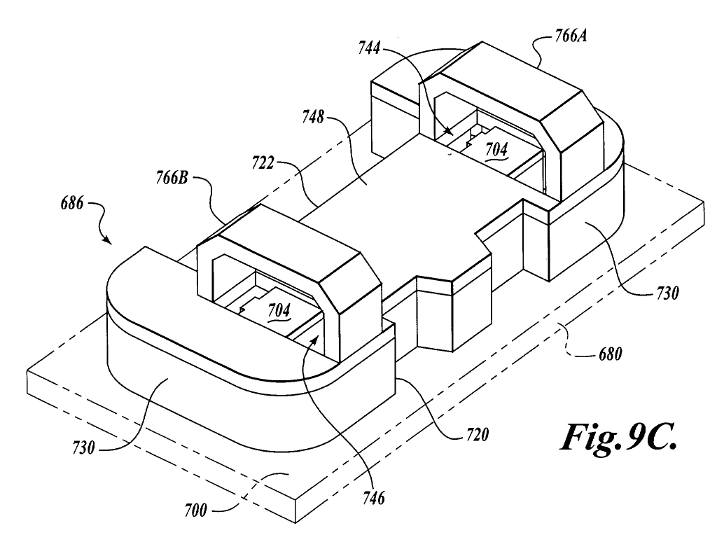

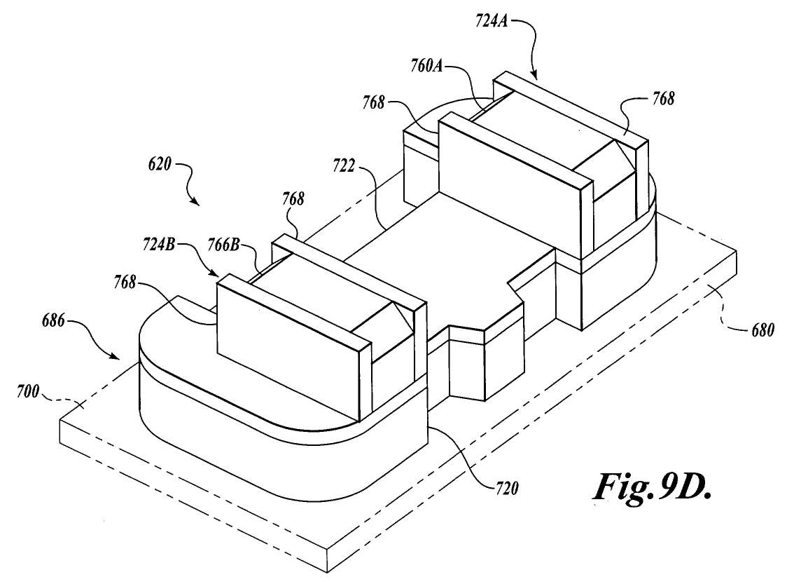

Referring now to FIGS. 8 and 9A-9D, another embodiment of a mold 620 and its corresponding insert 640 is shown. The mold is made from the method of the present invention described above including: 1) preselecting the shape of a desired packaging insert; 2) fabricating separate components of the mold into pre-selected shapes; and 3) assembling the mold components into the packaging insert mold, which defines a contiguous interior mold cavity having the predetermined shape of the desired packaging insert. Once the mold has been assembled, a bead foam material may be injection into the mold to form the preselected packaging insert. The mold 620 and its corresponding insert 640 is identical in construction, materials, and operation as the mold 20 and its corresponding insert 40 described above, except for the differences which will now be described in detail.

FIG. 8 illustrates a packaging insert 640 suitable for supporting a fragile product during shipping. The packaging insert 640 includes a multi-sided body 642 having a general C-shape and retaining members 664A and 664B. The body 642 is designed with a predetermined height, width and length that corresponds to the particular dimensions of the shipping container to be used during shipping. The body 642 includes an open-ended cavity 646 (partly shown) suitably shaped and sized to seat the end of a fragile product in a tight fitting manner. The retaining members 664 and 664B are integrally formed with and positioned on the outer surface of the body 642, i.e., the surface remote from the fragile product. In the embodiment shown, the retaining members 664A and 664B are disposed parallel to one another in a spaced-apart fashion, perpendicular to the major axis of the packaging insert 640. When packed in a shipping container, the outer surfaces 670A and 670D of the retaining members 664A and 664B, respectively, engage with the inner surfaces of the shipping container. Thus, the body 642 and the retaining members 664A and 664B retain the end of the fragile product in a tight fitting arrangement within the shipping container.

Referring now to FIGS. 9A-9D, one embodiment of a packaging insert mold 620 suitable for making a pre-selected packaging insert 640 of the type described above and illustrated in FIG. 8 will now be described in detail. As best shown in FIGS. 9B-9D, the packaging insert mold 620 is comprised of a base 680, a die 684, and an upper mold assembly 686, all of which are preferably constructed as individual components. Each mold component has a pre-selected shape such that when the mold components are assembled, the mold components form the mold 620 having an inner mold cavity. The inner mold cavity of the mold defines the pre-selected shape of the packaging insert 640. The individual components that make up the mold 620 will now be described in turn.

Referring now to FIGS. 9A and 9B, the base 680 may be generally rectangular in shape, or may be any other shape that has a sufficient top surface area for overlapping the upper mold assembly. The base 680 is a plate-like member having a top planar surface 700. Secured to the top planer surface 700 of the base 680 when assembled is the die 684, as shown in FIG. 9B. The die 684 is formed by a generally rectangular hollow support base 702 and generally rectangular top members 704 disposed at the end of the top surface of the support base 702. The support base 702 and the top members 704 may be secured together by any suitable mechanism, such as compression pins, screws, bolts, welding, or any combination thereof, to name a few. The top members 704 have top planar surfaces 706, and the support base 702 has a bottom planar surface (not shown) and outer side wall surfaces 712. The outer side wall surfaces 712 define an outer perimeter that corresponds to the shape and size of the packaging insert cavity. Thus, the outer perimeter defines the interior walls of the inner mold cavity.

The height of the die 684 (i.e., from the bottom planar surface of the support base 702 to the top planar surfaces 706 of the top members 704) is pre-selected to be greater than the height of the packaging insert body, by the thickness of the top member 704. When assembled, the die 684 is secured to the base 680 by any suitable mechanism, such as compression pins, screws, bolts, welding, or any combination thereof, to name a few. The die 684 is suitably dimensioned such that when secured to the base 680, a cavity 716 is formed around the die 684, between the outer side wall surfaces 7.12 and the interior surface of the upper mold assembly, as will be described in more detail below. Additionally, the cavity 716 is delimited by the top planar surface 700 of the base 680. As such, it will be appreciated that the cavity 736 is substantially equal in size and shape as the packaging insert body.

Referring now to FIG. 9D, the upper mold assembly 686 of the mold includes a base section 720, a top section 722, and protruding sections 724A and 724B, all of which are individually formed. As best shown in FIG. 9A, the base section 720 includes a plurality of side walls 730 of predetermined thickness contiguously connected to form a ring-like member. The height of the side walls 730 are pre-selected to be substantially equal the height of the packaging insert body. The side walls 730 of the base section 720 have a thickness suitable for supporting the top section 722. The inner surfaces 732 of the side walls 730 are generally planar and define the outer boundary of the cavity 736, the outer boundary corresponding in shape and size to the predetermined outer shape of the packaging insert body. When assembled, the base section 720 is positioned around the die and is supported by the base 680 such that the cavity 716 is formed between the outer surfaces 712 of the die 684 and the inner surfaces 732 of the base 720, and is delimited by the top planar surface 700 of the base 680, as shown best in FIG. 9B. In this position, the inner surfaces 732 of the side walls 730 are substantially orthogonal to the top planar surface 700 of the base 680.

The top section 722 of the upper mold assembly 686 is a plate-like member shaped and sized to correspond to the outer perimeter of the base section 720, shown best in FIG. 9C. The top section 722 has a top planar surface 748 and a bottom planar surface (not shown). The top section 722 is formed with two openings 744 and 746. In the embodiment shown, the openings 744 and 746 are spaced-apart, having a generally rectangular shaped geometry. The openings 744 and 746 are suitably positioned in the top section 722 to allow for the formation of the retaining members of the packaging insert when material is injected into the packaging insert mold. When assembled, the bottom planar surface (not shown) of the top section 722 is supported by the top surface of the base section 720 and the top surface of the support base of the die 684, such that the top planar surface 748 of the top section 722 lies substantially parallel to the top planar surface 700 of the base 680. When the top section 722 is properly aligned with the base section 720, the side walls of the top section 722 are flush with the outer surfaces 730 of the base section 720 and the top members 704 extend into the openings 744 and 746, as best shown in FIG. 9C. When the top section 722 is placed on the die, the cavity 736 (FIG. 9B) formed between the die and the base section 720, is partially enclosed. Thus, the bottom planar surface of the top section 722 delimits a portion of the inner mold cavity.

Referring now to FIGS. 9C and 9D, the upper mold assembly 686 further includes protruding sections 724A and 724B configured to surround the openings 744 and 746 of the top section 722. Each protruding section 724A and 724B is substantially equivalent in shape and construction, thus, only one will be described in detail. The protruding section 724A includes a generally C-shaped middle portion 766A flanked by plate-like end wall sections 768. When assembled to form the protruding section 724A, the end wall sections 768 abut against the longitudinal side surfaces of the middle section 766 to define a protruding section cavity (not shown). The shape and size of the protruding section cavity corresponds to the shape and size of the retaining members of the packaging insert. When assembled on the mold, the protruding sections 724A and 724B surround the openings 744 and 746, respectively, in the top section 722, as partially shown in FIG. 9C. This allows in the protruding section cavities (not shown) formed by the protruding sections 724A-724B to communicate with the cavity formed between the die and the base section 720. Thus, the protruding section cavities, in conjunction with the cavity 736, form the inner mold cavity for creating the packaging insert mold 640.

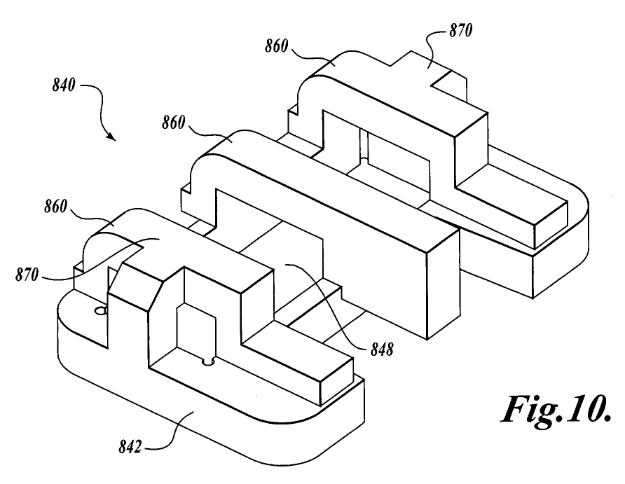

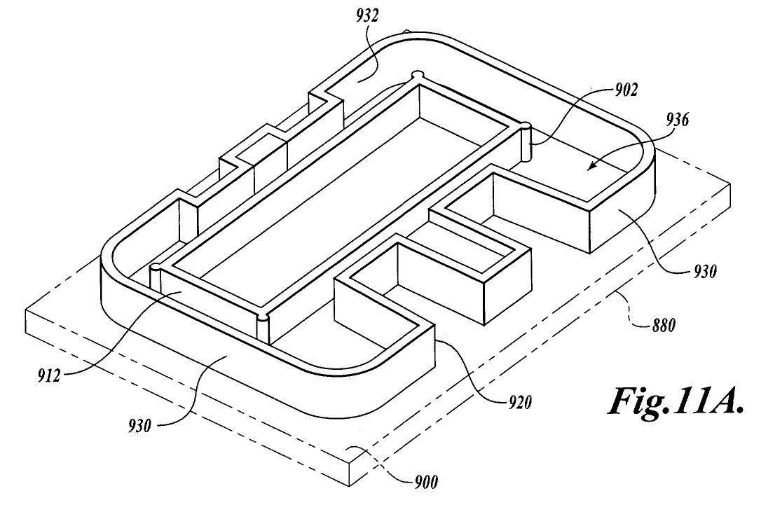

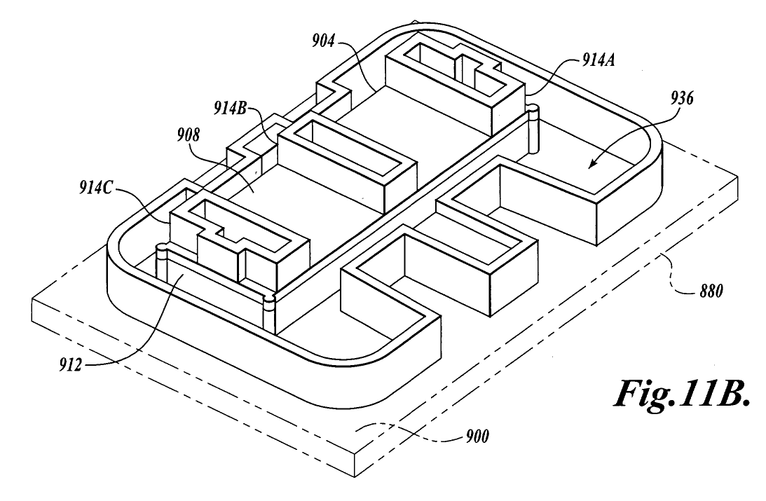

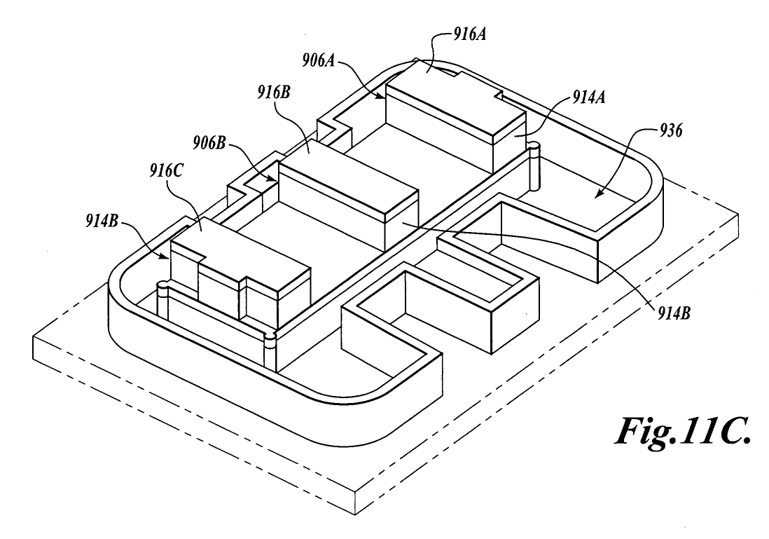

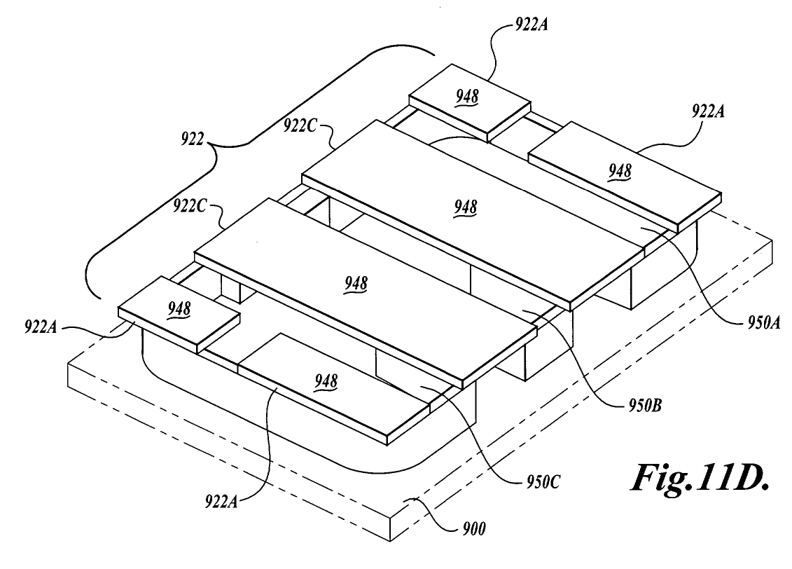

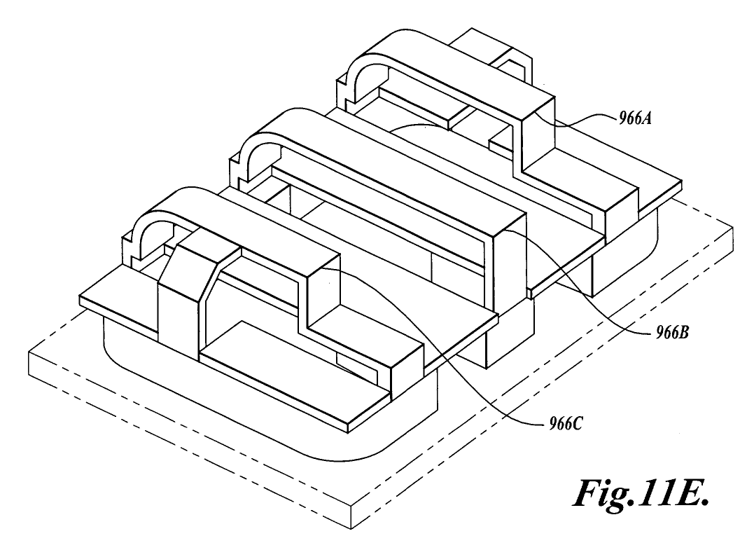

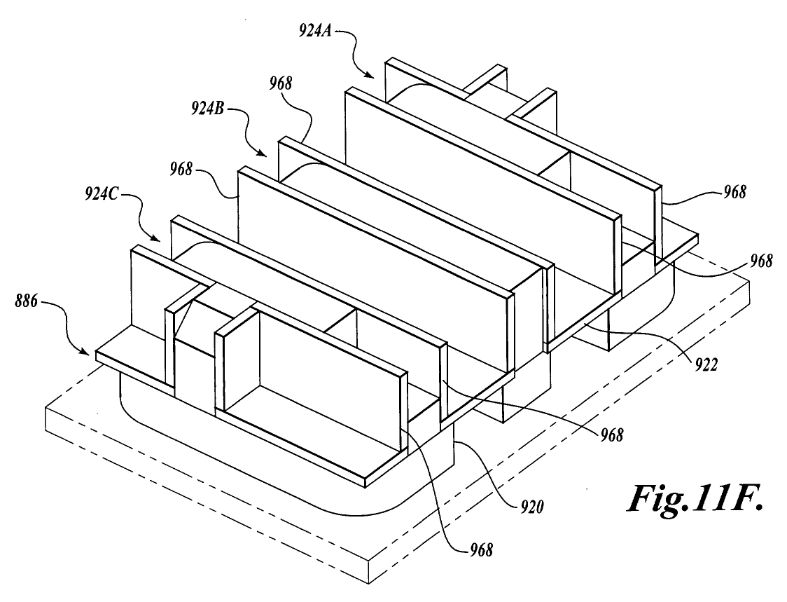

Referring now to FIGS. 10 and 11A-11F, another embodiment of a mold 820 and its corresponding insert 840 is shown. The mold is made from the method of the present invention described above, including (1) preselecting the shape of a desired packaging insert; (2) fabricating separate components of the mold into pre-selected shapes; and (3) assembling the mold components into the packaging insert mold, which defines a contiguous interior mold cavity having the predetermined shape of the desired packaging insert. Once the mold has been assembled, a bead foam material may be injection into the mold to form the preselected packaging insert. The mold 820 and its corresponding insert 840 is identical in construction, materials, and operation as the mold 20 and its corresponding insert 40 described above, except for the differences which will now be described in detail.

FIG. 10 illustrates another packaging insert 840 suitable for supporting a fragile product during shipping. The packaging insert 840 includes a multi-sided body 842 and a plurality of retaining members 860. The body 842 is designed with a predetermined height, width, and length that correspond to the particular dimensions of the shipping container to be used. The body 842 includes an open-ended cavity 848 suitable shaped and sized to seat the end of a fragile product, in a tight fitting manner. The retaining members 860 are integrally formed with and positioned on the outer surface of the body 842, i.e., the surface remote from fragile product. In the embodiment shown, the retaining members 860 are disposed parallel to one another in a spaced apart fashion, perpendicular to the major axis of the packaging insert 840. When packed in a shipping container, the outer surfaces 870 of the retaining members 860 engage with the inner surfaces of the shipping container. Thus, the body 842 and the retaining members 860 retain the end of the fragile product in a tight fitting arrangement within the shipping container.

Referring now to FIGS. 11A-11F, one embodiment of a packaging insert mold 820 suitable for making a pre-selected packaging insert 840 of the type described above and illustrated in FIG. 10 will now be described in detail. As best shown in FIGS. 11C and 11F, the packaging insert mold 820 is comprised of a base 880, a die 884, and an upper mold assembly 886, all of which are preferably constructed as individual components. Each mold component has a pre-selected shape such that when the mold components are assembled, the mold components form the mold 820 having an inner mold cavity. The inner mold 820 cavity of the mold defines the pre-selected shape of the packaging insert 840. The individual components of that make up the mold 820 will now be described in turn.

Referring now to FIG. 11A, the base 880 may be generally rectangular in shape or may be any other shape that has a sufficient top surface area for overlapping the upper-mold assembly. The base 880 is preferably a plate-like member having a top planar surface 900. Secured to the top planer surface 900 of the base 880 when assembled is the die 884, as shown best in FIGS. 11A-11C. The die 884 is formed by a generally rectangular support base 902, preferably hollow, a generally rectangular top member 904, and a plurality of spaced apart projections 906A-906C. The top member 904 has a top planar surface 908 and a bottom planar surface (not shown), and the support base 902 has outer side wall surfaces 912. The outer side wall surfaces 912 define an outer perimeter that corresponds to the shape and size of the packaging insert cavity. Thus, the outer perimeter defines the interior walls of the inner mold cavity.

The projections 906A-906C preferably includes respective bases 914A-914C and upper plates 916A-916C, however, the projection 906 may be unitary in construction. When assembled, the die 884 is preferably centered on the base 880 and secured thereto by any suitable mechanism, such as compression pins, screws, bolts, welding, or any combination thereof, to name a few. Additionally, the component of the die are preferably secured together by welding, adhesive or the like. The die 884 is suitably dimensioned such that when secured to the base 880, a cavity 936 is formed around the die 884, between the outer surfaces 912 and the interior surface of the upper mold assembly, as will be described in more detail below. Additionally, the cavity 936 is delimited by the top planar surface 900 of the base 880. As such, it will be appreciated that the cavity 936 is substantially equal in size and shape as the packaging insert body.

Referring now to FIG. 11F, the upper mold assembly 886 of the mold 820 includes a base section 920, a top section 922, and a plurality of protruding sections 924A-924C, all of which are individually formed. The base section 920 includes a plurality of side walls 930 of predetermined thickness contiguously connected to form a ring-like member, as best shown in FIG. 11A. The height of the side walls 930 are pre-selected to be substantially equal the height of the packaging insert body. The side walls 930 of the base section 920 have a thickness suitable for supporting the top section 922. The inner surfaces 932 of the side walls 930 are generally planar and define the outer boundary of cavity 936, the outer boundary corresponding in shape and size to the predetermined outer shape of the packaging insert body. When assembled, the base section 920 is positioned around the die and is supported by the base 880 such that the cavity 936 is formed between the outer surfaces 912 of the die 884 and the inner surfaces 932 of the base 920, and is delimited by the top planar surface 900 of the base 880, as shown best in FIG. 11B. When supported by the base 880, the inner surfaces 932 of the side walls 930 are substantially orthogonal to the top planar surface 900 of the base 880.

For ease of illustration, FIG. 11D is a perspective view of the base section 920 mounted to the base 880, with top section 922 positioned on the base section 920. The top section 922 of the upper mold assembly 886 is a plurality of plate-like members 922A-922D. Each member 922A-922D of the top section 922 has a top planar surface 948 and a bottom planar surface (not shown). In the embodiment shown, the members 922A-922B are spaced apart across the top surface of the base section 920 to form openings 950A-950C. The openings 950A-950C are suitably positioned in the top section 922 to allow for the formation of the retaining members of the packaging insert when material is injected into the packaging insert mold. When assembled, the bottom planar surface (not shown) of the top section 922 is supported by the top surface of the base section 920 and the top planar surface of the top section of the die (not shown), such that the top planar surfaces 948 of the top section 922 lies substantially parallel to the top planar surface 900 of the base 880. When the top section 922 is placed on the die, the cavity 936 formed between the die 984 and the base section 920 is partially enclosed. Thus, the bottom planar surface of the top section 922 delimits a portion of inner mold cavity.

Referring now to FIGS. 11E and 11F, the upper mold assembly 886 further includes protruding sections 924A, 924B, and 924C configured to surround the openings formed by the top section 122. Each protruding section 924A-924B is substantially equivalent in construction, thus, only one will be described in detail. The protruding section 924A includes a middle section 966A and end wall sections 968. When assembled to form the protruding section 924B, the end wall sections abut against the edges of the middle section 966A to define a protruding section cavity (not shown). The shape and size of the protruding section cavity corresponds to the shape and size of the retaining members 860 of the packaging insert 840 (see FIG. 10). When assembled on the mold 820, the protruding sections 924A and 924C surround the openings in the top section 922, as best shown in FIG. 11F. This results in the protruding section cavities (not shown), formed by the protruding sections 924A-924C, to communicate with the cavity 936 formed between the die and the base section 920. Thus, the protruding section cavities, conjunction with the cavity 936, form the inner mold cavity for creating the packaging insert mold 840.

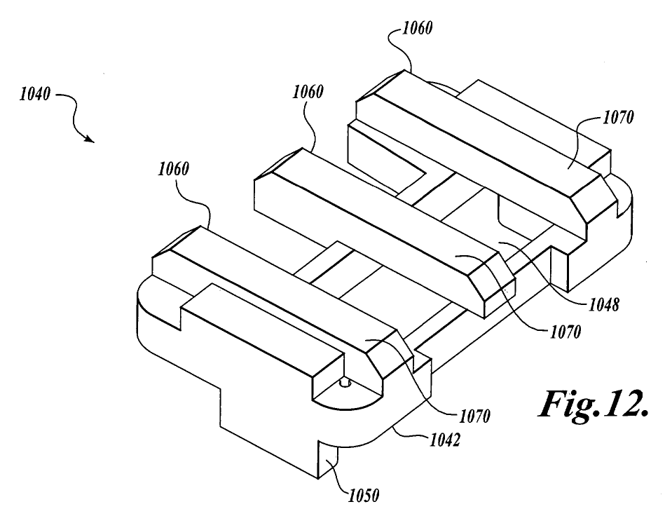

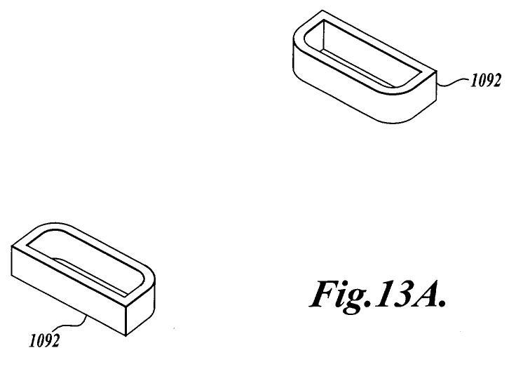

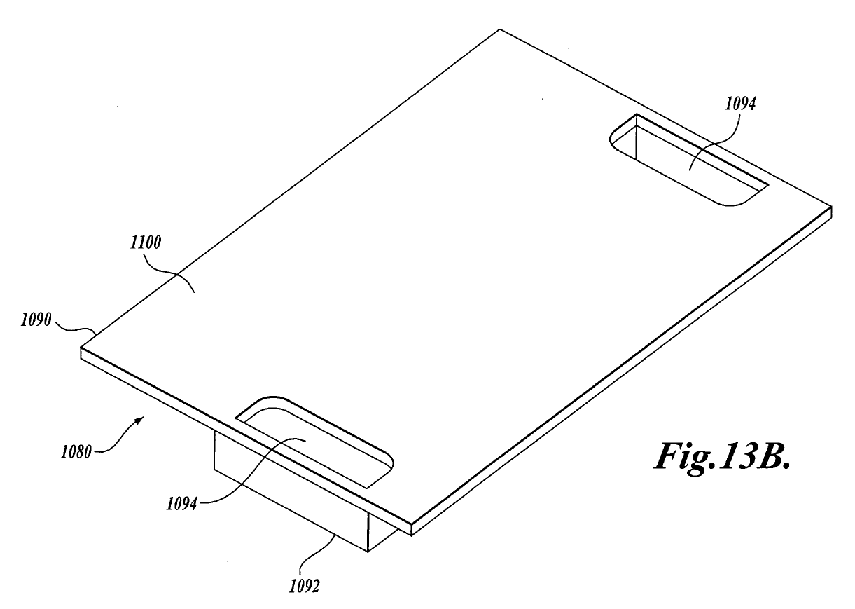

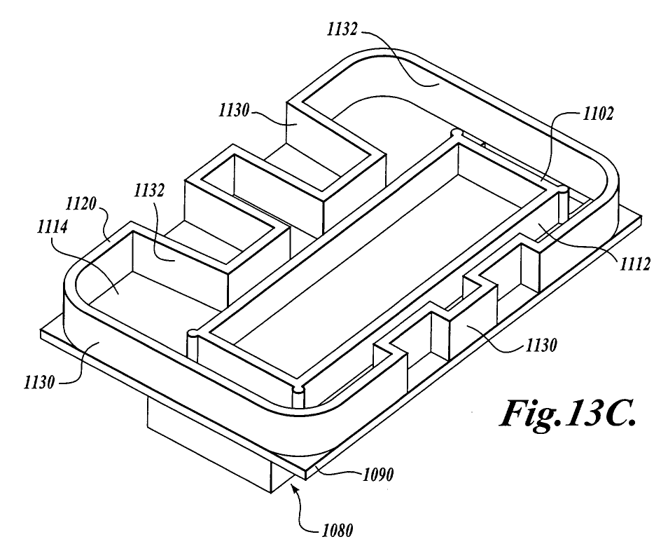

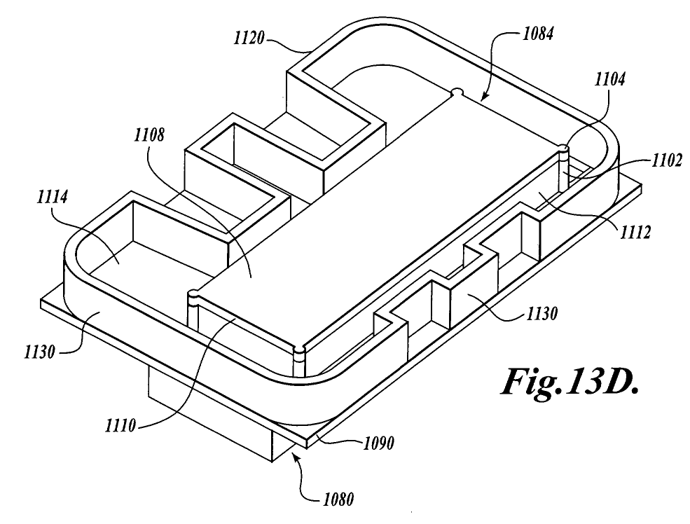

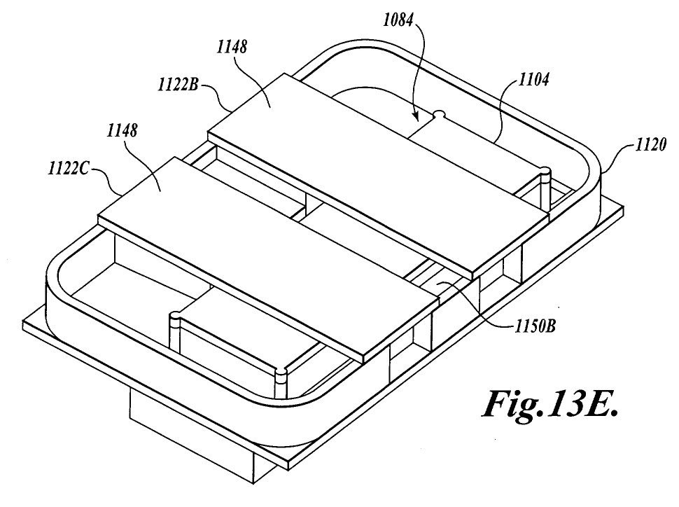

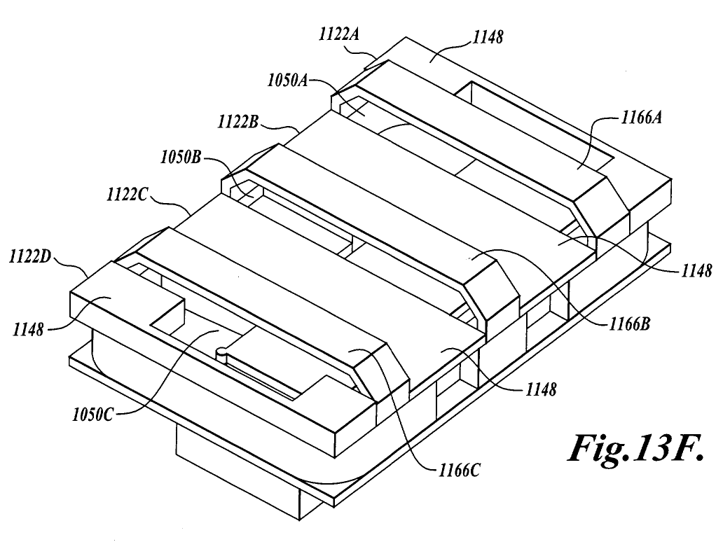

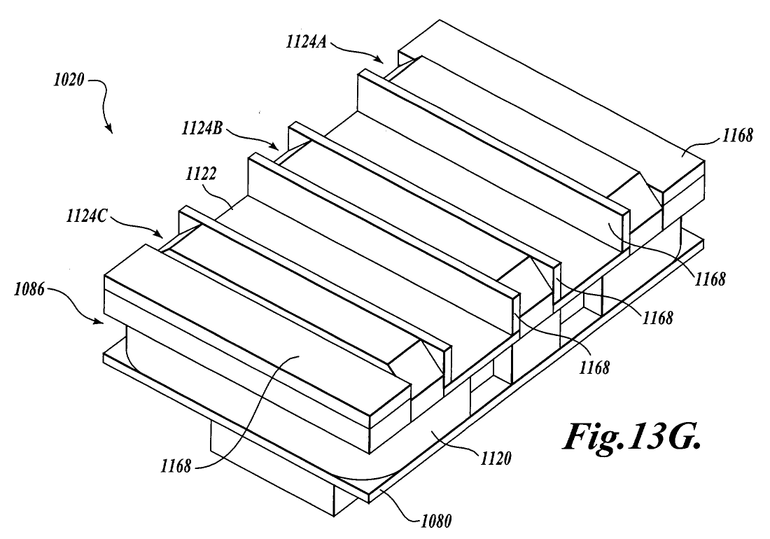

Referring now to FIGS. 12 and 13A-13G, another embodiment of a mold 1020 and its corresponding insert 1040 is shown. The mold is made from the method of the present invention described above including: 1) preselecting the shape of a desired packaging insert; 2) fabricating separate components of the mold into pre-selected shapes; and 3) assembling the mold components into the packaging insert mold, which defines a contiguous interior mold cavity having the predetermined shape of the desired packaging insert. Once the mold has been assembled, a bead foam material may be injection into the mold to form the preselected packaging insert. The mold 1020 and its corresponding insert 1040 is identical in construction, materials, and operation as the mold 20 and its corresponding insert 40 described above, except for the differences which will now be described in detail.

FIG. 12 illustrates another packaging insert 1040 suitable for supporting a fragile product during shipping. The packaging insert 1040 includes a multi-sided body 1042 and a plurality of retaining members 1060. The body 1042 is designed with a predetermined height, width, and length that correspond to the particular dimensions of the shipping container to be used. The body 1042 includes an open-ended cavity 1048 suitable shaped and sized to seat the end of a fragile product, in a tight fitting manner. The body 1048 may also include extensions 1050 that extend from the body 1048 opposite the retaining members 1060, if desired. The retaining members 1060 are integrally formed with and positioned on the outer surface of the body 1042, i.e., the surface remote from fragile product. In the embodiment shown, the retaining members 1060 are disposed parallel to one another in a spaced apart fashion, perpendicular to the major axis of the packaging insert 1040. When packed in a shipping container, the outer surfaces 1070 of the retaining members 1060 engage with the inner surfaces of the shipping container. Thus, the body 1042 and the retaining members 1060 retain the end of the fragile product in a tight fitting arrangement within the shipping container.

Referring now to FIGS. 13A-13G, one embodiment of a packaging insert mold 1020 suitable for making a pre-selected packaging insert 1040 of the type described above and illustrated in FIG. 12 will now be described in detail. As best shown in FIGS. 13D and 13G, the packaging insert mold 1020 is comprised of a base 1080, a die 1084, and an upper mold assembly 1086, all of which are preferably constructed as individual components. Each mold component has a pre-selected shape such that when the mold components are assembled, the mold components form the mold 1020 having an inner mold cavity. The inner mold cavity of the mold 1020 defines the pre-selected shape of the packaging insert 1040. The individual components that make up the mold 1020 will now be described in turn.

Referring now to FIGS. 13A-13B, the base 1080 may be generally rectangular in shape or may be any other shape that has a sufficient top surface area for overlapping the upper mold assembly. In the embodiment shown, the base 1080 includes a plate-like member 1090 having a top planar surface 1100, and two substantially rectangular members 1092. The members 1092 are hollow, and are positioned to communicate with openings 1094 in the plate-like member 1090. The end of the rectangular members 1092 opposite the plate-like member 1090 is closed by a suitable shaped plate (not shown) to form a cavity therein. As such, the cavity formed by the members 1092 defines the insert body extensions 1050 of the packaging insert 1240 of FIG. 12.

As shown best in FIGS. 13C and 13D, the die 1084 is secured to the top planer surface 1100 of the plate-like member 1090 when assembled. The die 1084 is formed by a generally rectangular support base 1102, preferably hollow, and a generally rectangular top member 1104 that corresponds in size and shape to the support base 1102. The support base 1102 and the top member 1104 may be secured together by any suitable mechanism, such as compression pins, screws, bolts, welding, or any combination thereof, to name a few. The top member 1104 has a top planar surface 1108, a bottom planar surface (not shown), and outer side wall surfaces 1110, and the support base 1102 has outer side wall surfaces 1112. When assembled, the outer side wall surfaces 1010 and 1112 define an outer perimeter that corresponds to the shape and size of the open ended cavity 1048 of the packaging insert body 1042 (FIG. 12). As such, it will be appreciated that the outer perimeter defines the interior walls of the inner mold cavity.

When assembled, the die 1084 is preferably centered on the plate-like member 1090 of base 1080 and secured thereto by any suitable mechanism, such as compression pins, screws, bolts, welding, or any combination thereof, to name a few. Additionally, the components 1102 and 1104 of the die 1084 are preferably secured together by welding, adhesive or the like. The die 1084 is suitably dimensioned such that when secured to the base 1080 as assembled, a cavity 1114 is formed around the die 1084, between the outer surfaces 1110 and 1112 and the interior surface of the upper mold assembly, as will be described in more detail below. The cavity 1114 is in communication with the extension cavities described above. Additionally, the cavity 1114 is delimited by the top planar surface 1100 of the plate-like member 1090. As such, it will be appreciated that the cavity 1114 is substantially equal in size and shape as the packaging insert body.

Referring now to FIG. 13G, the upper mold assembly 1086 of the mold 1020 includes a base section 1120, a top section 1122, and a plurality of protruding sections 1124A-1124C, all of which are individually formed. The base section 1120 includes a plurality of side walls 1130 of predetermined thickness contiguously connected to form a ring-like member, as best shown in FIGS. 132C and 132D. The height of the side walls 1130 are pre-selected to be substantially equal the height of the packaging insert body. The side walls 1130 of the base section 1120 have a thickness suitable for supporting the top section 1122. The inner surfaces 1132 of the side walls 1130 are generally planar and defines the outer boundary of the cavity 1114, the outer boundary corresponding in shape and size to the predetermined outer shape of the packaging insert body. When assembled, the base section 1120 is positioned around the die and is supported by the plate-like member 1090 such that the cavity 1114 is formed between the outer surfaces 1112 of the die 1084 and the inner surfaces 1132 of the base 1120, and is delimited by the top planar surface 700 of the base 680, as shown best in FIGS. 13C and 13D. In this position, the inner surfaces 1132 of the side walls 1130 are substantially orthogonal to the top planar surface 1100 of the plate-like member 1090.

The top section 1122 of the upper mold assembly 1086 is a plurality of plate-like members 1122A-1122D, as best shown in FIGS. 13E-13F. Each member 1122A-1122D of the top section 1122 has a top planar surface 1148 and a bottom planar surface (not shown). In the embodiment shown, the members 1122A-1122D are spaced apart across the top surface of the base section 1120 to form openings 1150A-1150C. The openings 1150A-1150C are suitably positioned in the top section 1122 to allow for the formation of the retaining members of the packaging insert when material is injected into the packaging insert mold. When assembled, the bottom planar surfaces (not shown) of the top sections 1122A-1122D are supported by the top surface of the base section 1120 and the top planar surface of the top section 1104 of the die such that the top planar surfaces 1148 of the top sections 1122A-1122D lie substantially parallel to the top planar surface 1100 of the plate-like member 1090. When the top section 1122 is placed on the die, the cavity 1114 formed between the die 1084 and the base section 1120 is partially enclosed. Thus, the bottom planar surface of the top section 1122 delimits a portion of inner mold cavity.

Referring now to FIGS. 13E and 13F, the upper mold assembly 1086 further includes protruding sections 1124A, 1124B, and 1124C configured to surround the openings 1050A-1050C formed by the top section 122. Each protruding section 1124A-1124C is substantially equivalent in construction, thus, only one will be described in detail. The protruding section 1124B includes a C-shaped middle section 1166B and end wall sections 1168. When assembled to form the protruding section 1124B, the end wall sections 1168 are disposed orthogonal to the top section 1122 and abut against the edges of the middle section 1166A to define a protruding section cavity (not shown). With respect to the protruding sections 1124A and 1124C, the outermost end wall sections 1168 are disposed parallel with and supported by the top sections 1122A and 1122D, respectively. The shape and size of the protruding section cavity corresponds to the shape and size of the retaining members 1060 of the packaging insert 1040 (see FIG. 10). When assembled on the mold 1020, the protruding sections 1124A-1124C surround the openings 1050A-1050C in the top section 1122, as best shown in FIG. 11F. This results in the protruding section cavities (not shown), formed by the protruding sections 1124A-1124C, communicating with the cavity 1114. Thus, the protruding section cavities, in conjunction with the cavity 1114, form the inner mold cavity for creating the packaging insert mold 1040.

While the alternative embodiments of the packaging insert molds just described were illustrated without an alignment plate, it will be appreciated that an alignment plate may be either included or omitted in all of the embodiment of the present invention.

While the preferred embodiments of the invention have been illustrated and described, it will be appreciated that various changes can be made therein without departing from the spirit and scope of the invention.

The embodiments of the invention in which an exclusive property or privilege is claimed are defined as follows:

1. A method of making a packaging insert mold for making a packaging insert that supports an article in a shipping container, the method comprising:
fabricating a plurality of separate parts of a mold, the parts having pre-selected shapes such that when assembled, the fabricated parts form a packaging insert mold with a contiguous inner cavity that defines a pre-selected shape of a packaging insert; and
assembling the separately fabricated parts to form the packaging insert mold having the contiguous inner cavity.

2. The method of claim 1, wherein fabricating separate parts of a mold includes
obtaining a plurality of plates of metallic material having pre-selected thicknesses, at least one plate having a thickness that correspond to one pre-selected dimension of the packaging insert;
cutting the parts of the mold having the pre-selected shapes from the plates of metallic material.

3. The method of claim 2, wherein cutting the parts of the mold having the pre-selected shapes from the plates of metallic material further are cut from the plates of metallic material by a high pressure jet of fluid.

4. The method of claim 1, wherein assembling the separately fabricated parts to form the mold further includes
fastening the assembled parts of the mold together to form the mold.

5. A method of making a packaging insert for supporting an article in a shipping container, comprising:
a) fabricating separate parts of a mold from plates of material, the parts having pre-selected shapes such that when assembled, the fabricated parts form a packaging insert mold with a contiguous inner cavity that defines a pre-selected shape of a packaging insert,
b) assembling the separately fabricated parts into the mold having a contiguous inner cavity; and
c) injecting an injectable molding material into the cavity of the mold to form the packaging insert, the packaging insert having the pre-selected shape of the packaging insert.

6. The method of claim 5, wherein the separate parts of the mold include
i) abase;
ii) a die having side walls, and
iii) an upper mold assembly including a base section having a pre-selected shape and an opening adapted to receive the die such that a cavity is formed between the side walls of the die and the base section.

7. The method of claim 6, wherein the upper mold assembly further includes a top section having a shape corresponding to the opening of the base section, and at least one protruding section which defines a second cavity.

8. The method of claim 7, wherein the second cavity formed by the protruding section is in communication with the first cavity, the first and second cavities forming the contiguous inner cavity.

9. The method of claim 5, wherein fabricating separate parts of a mold includes
obtaining a plurality of plates of metallic material having pre-selected thicknesses, at least one plate having a thickness that correspond to one pre-selected dimension of the packaging insert; and
cutting out the parts of the mold having the pre-selected shapes from the plates of material.

10. The method of claim 9, wherein the parts of the mold having the pre-selected shapes from the plates of material further are cut by a high pressure jet of fluid.

11. The method of claim 10, wherein the plates of material are aluminum plates.

12. A mold for making a packaging insert having a pre-selected shape, the packaging insert utilized to support an article in a shipping container, comprising:
a base having a top planar surface;
a die having a pre-selected shape and a pre-selected height, the die supported by the base; and
an upper mold assembly removably mounted to and supported by the base, the upper mold assembly including:
a base section having a pre-selected shape and an opening adapted to receive the die such that a first cavity is formed between the die and the base section, wherein the first cavity forms at least a portion of a single contiguous inner cavity defining the pre-selected shape of the packaging insert; and
a top section having a shape corresponding to the opening in the base section and sized to be supported by the base section.

13. The mold of claim 12, further including an alignment member having an opening adapted to receive the upper mold assembly, the alignment member operable to align the upper mold assembly with respect to the base.

14. The mold of claim 12, wherein the top section includes at least one opening, and the upper mold assembly includes at least one protruding section defining a second cavity, the protruding section surrounding the respective opening of the top section;
wherein the first cavity communicates with the second cavity formed by the protruding section to define the single contiguous inner cavity defining the pre-selected shape of the packaging insert.

15. The mold of claim 14, wherein the protruding section includes a middle section and two end section disposed on opposite sides of the middle section, wherein the middle section and the end sections are sized and configured to define the second cavity.

16. The mold of claim 12, wherein the base section has a pre-selected height, the pre-selected height of the base section being substantially equal to the pre-selected height of the die.
